(19) United States
(12) Patent Application Publication
(10) Pub. No.: US 2005/0218718 A1
(43) Pub. Date: Oct. 6, 2005

(54) Deceleration control apparatus and method for a vehicle

(75) Inventors: Kunihiro Iwatsuki, Toyota-shi (JP); Kazuyuki Shiiba, Susono-shi (JP); Hiroaki Fujinami, Susono-shi (JP); Masato Seki, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/081,584

(22) Filed: Mar. 17, 2005

(30) Foreign Application Priority Data
Apr. 6, 2004 (JP) 2004-112384

(51) Int. Cl. B60T 8/32

(52) U.S. Cl. 303/177

(57) ABSTRACT

A deceleration control apparatus for a vehicle, which performs deceleration control on the vehicle by an operation of a brake system that applies a braking force to the vehicle and a shift operation which shifts a transmission of the vehicle into a relatively low speed or speed ratio, changes, as the deceleration control, the braking force applied to a non-driven wheel of the vehicle and the braking force applied to a driven wheel of the vehicle based on a deceleration F applied to the vehicle and an engine braking force Fe that acts on the driven wheel of the vehicle. The engine braking force includes inertia force and changes in the engine braking force produced by a shift, as well as engine braking force produced as a result of the accelerator being turned off.

### INCORPORATION BY REFERENCE

The disclosure of Japanese Patent Application No. 2004-112384 filed on Apr. 6, 2004, including its specification, drawings and abstract is incorporated herein by reference in its entirety.

### BACKGROUND OF THE INVENTION

1. Field of the Invention

The invention relates to a deceleration control apparatus and a deceleration control method for a vehicle. More specifically, this invention relates to a deceleration control apparatus and a deceleration control method for a vehicle, which makes it possible to inhibit the vehicle from becoming unstable when deceleration acts on the vehicle.

2. Description of the Related Art

Japanese Patent Application Laid-open No. JP-A-10-230829 discloses technology which, in a vehicle in which at least a front wheel serves as a driven wheel, drives a hydraulic pressure control apparatus so that braking force of a rear wheel is less than the braking force of the front wheel when it is determined that engine braking force is acting on the vehicle.

Furthermore, technology that cooperatively controls an automatic transmission and brakes is known which applies the brakes when the automatic transmission is manually shifted in a direction that engages the engine brake. The technology disclosed in Japanese Patent Application Laid-open No. JP-A-63-38030 is one such automatic transmission and brake cooperative control apparatus.

According to the technology disclosed in Japanese Patent Application Laid-open No. JP-A-63-38030, when an automatic transmission (A/T) has been manually shifted so that the engine brake will engage, the brakes of the vehicle are applied to prevent free running of the vehicle due to the vehicle being in a neutral state between the time that the shift starts and the time that the engine brake engages.

It is desirable to inhibit the vehicle from becoming unstable when deceleration acts on the vehicle.

In particular, with control by which both a brake system and a shift of a transmission are cooperatively controlled when decelerating the vehicle, the amount of engine braking force changes depending on the progression of control (i.e., the shift), so it necessary to distribute the braking force accordingly.

Also, with technology that performs deceleration control of the vehicle irrespective of a shift of the transmission, using only the brake system when deceleration control of the vehicle is performed automatically based on various conditions ahead of the vehicle such as a corner radius, road gradient, distance to a preceding vehicle, and friction coefficient μ of a road surface, it is desirable to decelerate the vehicle while keeping it stable during deceleration control because the intention to decelerate by a driver is relatively weak compared to when the driver applies the foot brake.

Moreover, when the vehicle is decelerated by operating the brake system, including the case in which the driver applies the foot brake, it is desirable that control suitable for the conditions be performed so that the vehicle does not become unstable when deceleration acts on the vehicle.

### SUMMARY OF THE INVENTION

This invention thus provides a deceleration control apparatus and a deceleration control method for a vehicle, which is capable of inhibiting the vehicle from becoming unstable when deceleration acts on the vehicle.

A deceleration control apparatus for a vehicle according to a first aspect of the invention performs deceleration control on the vehicle by an operation of a brake system which applies a braking force to the vehicle and a shift operation which shifts a transmission of the vehicle into a relatively low speed or speed ratio. According to this deceleration control, the braking force applied to a non-driven wheel of the vehicle and the braking force applied to a driven wheel of the vehicle are changed based on a deceleration applied to the vehicle and engine braking force that acts on the driven wheel of the vehicle.

In the first aspect of the invention, the engine braking force can include inertia force and changes in the engine braking force produced by a shift, as well as engine braking force produced as a result of the accelerator being turned off. Furthermore, deceleration (total braking force F) applied to the vehicle can be obtained as deceleration control from the target deceleration and an ideal distribution ratio R can be obtained from that total braking force F.

In the deceleration control according to the first aspect of the invention, a target deceleration can be set based on at least one of a curve ahead of the vehicle, a road gradient, slipperiness of a road surface, and a distance to a preceding vehicle, and the deceleration control can be performed such that a deceleration applied to the vehicle matches the target deceleration.

Also in the deceleration control according to the first aspect of the invention, when a shift command is output either in response to a manual operation by a driver or based on a shift map for shifting the transmission, a target deceleration corresponding to a shift in response to the shift command can be set, and the deceleration control can be performed such that a deceleration applied to the vehicle matches the target deceleration.

Also in the first aspect of the invention, the braking force applied to the non-driven wheel of the vehicle and the braking force applied to the driven wheel of the vehicle can be changed when there is a curve ahead of the vehicle, when a steering angle of the vehicle is equal to, or greater than, a predetermined value, or when the slipperiness of the road surface is equal to, or greater than, a set value.

In the first aspect of the invention, feedback control in the brake system can be performed based on the target deceleration of the deceleration control and the actual deceleration acting on the vehicle.

A deceleration control apparatus for a vehicle according to a second aspect of the invention performs deceleration control on the vehicle by operation of a brake system that applies a braking force to the vehicle. A target deceleration is set based on at least one of a curve ahead of the vehicle, a road gradient, slipperiness of a road surface, and a distance to a preceding vehicle. The braking force applied to a non-driven wheel of the vehicle and the braking force applied to a driven wheel of the vehicle are changed, based on an engine braking force acting on the driven wheel of the vehicle, when the deceleration control is performed such that a deceleration applied to the vehicle matches the target deceleration.

In technology that performs deceleration control on a vehicle irrespective of a shift of the transmission using only the brake system, when deceleration control of the vehicle is performed automatically based on various conditions ahead of the vehicle such as a corner radius, a road gradient, a distance to a preceding vehicle, or a friction coefficient μ of the road surface (hereinafter simply referred to as, “road ratio μ”), it is desirable to decelerate the vehicle while keeping it stable during deceleration control because the intention to decelerate by a driver is relatively weak compared to when the driver applies the foot brake. In this exemplary embodiment, the vehicle is able to be decelerated while being kept stable during deceleration control because the braking force applied to the non-driven wheel and the braking force applied to the driven wheel is changed based on the engine braking force that acts on the driven wheel of the vehicle.

A deceleration control apparatus for a vehicle according to a third aspect of the invention performs deceleration control of the vehicle by operation of a brake system that applies a braking force to the vehicle. The braking force applied to a non-driven wheel of the vehicle and the braking force applied to a driven wheel of the vehicle are changed, based on an engine braking force acting on the driven wheel of the vehicle, when there is a curve ahead of the vehicle, when a steering angle of the vehicle is equal to, or greater than, a predetermined value, or when the slipperiness of the road surface is equal to, or greater than, a set value.

In a case in which the vehicle is decelerated by operation of the brakes, including a case in which the driver depresses the footbrake, it is desirable to keep the vehicle from becoming unstable when deceleration acts on the vehicle when i) there is a curve ahead of the vehicle, ii) the steering angle of the vehicle is equal to, or greater than, a predetermined value, or iii) the slipperiness of the road surface is equal to, or greater than, a set value. According to this aspect of the invention, the vehicle is able to be decelerated while being kept stable because the braking force applied to the non-driven wheel and the braking force applied to the driven wheel are changed based on the engine braking force that acts on the driven wheel of the vehicle.

In the third aspect of the invention, the brake system may be at least one of means for braking a rotation of a vehicle wheel and means for generating power based on the rotation of the vehicle wheel.

The deceleration control apparatus for a vehicle in each of the aspects of the invention inhibit the vehicle from becoming unstable when deceleration acts on the vehicle.

A deceleration control method for a vehicle according to a fourth aspect of the invention performs deceleration control on the vehicle by an operation of a brake system which applies a braking force to the vehicle and a shift operation which shifts a transmission of the vehicle into a relatively low speed or speed ratio. According to this deceleration control, the braking force applied to a non-driven wheel of the vehicle and the braking force applied to a driven wheel of the vehicle are changed based on a deceleration applied to the vehicle and engine braking force that acts on the driven wheel of the vehicle.

A deceleration control method for a vehicle according to a fifth aspect of the invention performs deceleration control on the vehicle by operation of a brake system that applies a braking force to the vehicle. A target deceleration is set based on at least one of a curve ahead of the vehicle, a road gradient, slipperiness of a road surface, and a distance to a preceding vehicle. The braking force applied to a non-driven wheel of the vehicle and the braking force applied to a driven wheel of the vehicle are changed, based on an engine braking force acting on the driven wheel of the vehicle, when the deceleration control is performed such that a deceleration applied to the vehicle matches the target deceleration.

A deceleration control method for a vehicle according to a sixth aspect of the invention performs deceleration control of the vehicle by operation of a brake system that applies a braking force to the vehicle. The braking force applied to a non-driven wheel of the vehicle and the braking force applied to a driven wheel of the vehicle are changed, based on an engine braking force acting on the driven wheel of the vehicle, when there is a curve ahead of the vehicle, when a steering angle of the vehicle is equal to, or greater than, a predetermined value, or when the slipperiness of the road surface is equal to, or greater than, a set value.

### BRIEF DESCRIPTION OF THE DRAWINGS

The above-mentioned objects, features, advantages, technical and industrial significance of this invention will be better understood by reading the following detailed description of preferred embodiments of the invention, when considered in connection with the accompanying drawings, in which:

FIGS. 1A and 1B are a flowchart illustrating operation of a deceleration control apparatus for a vehicle according to a first exemplary embodiment of the invention;

FIG. 2 is a block diagram schematically showing the deceleration control apparatus for a vehicle according to the first exemplary embodiment of the invention;

FIG. 3 is a skeleton view of an automatic transmission of the deceleration control apparatus for a vehicle according to the first exemplary embodiment of the invention;

FIG. 4 is a table showing engagement/disengagement combinations of the automatic transmission shown in FIG. 3;

FIG. 5 is a shift diagram for the automatic transmission shown in FIG. 3;

FIG. 6 is a view showing the control execution boundary line of the deceleration control apparatus for a vehicle according to the first exemplary embodiment of the invention;

FIG. 7 is a downshift determination map of the deceleration control apparatus for a vehicle according to the first exemplary embodiment of the invention;

FIG. 8 is a flowchart illustrating an operation for obtaining the braking force distribution ratio of the deceleration control apparatus for a vehicle according to the first exemplary embodiment of the invention;

FIG. 9 is a map for obtaining the total braking force of the deceleration control apparatus for a vehicle according to the first exemplary embodiment of the invention;

FIG. 10 is a map for obtaining the ideal distribution ratio of the deceleration control apparatus for a vehicle according to the first exemplary embodiment of the invention;

FIG. 11 is a time chart illustrating the operation of the deceleration control apparatus for a vehicle according to the first exemplary embodiment of the invention;

FIGS. 12A and 12B are a flowchart illustrating the operation of a deceleration control apparatus for a vehicle according to a second exemplary embodiment of the invention;

FIG. 13 is a target deceleration map of the deceleration control apparatus for a vehicle according to the second exemplary embodiment of the invention;

FIG. 14 is a speed target deceleration map of the deceleration control apparatus for a vehicle according to the second exemplary embodiment of the invention;

FIG. 15 is a view showing the deceleration produced by an output shaft rotation speed and the speed in the deceleration control apparatus for a vehicle according to the second exemplary embodiment of the invention;

FIG. 16 is a view showing the relationship between the speed target deceleration, the current gear speed deceleration, and the maximum target deceleration in the deceleration control apparatus for a vehicle according to the second exemplary embodiment of the invention;

FIG. 17 is a graph illustrating the deceleration for each vehicle speed in each gear speed in the deceleration control apparatus for a vehicle according to the first exemplary embodiment of the invention;

FIG. 18 is a time chart illustrating the operation of the deceleration control apparatus for a vehicle according to the second exemplary embodiment of the invention;

FIG. 19 is a flowchart illustrating control by a deceleration control apparatus for a vehicle according to a third exemplary embodiment of the invention;

FIG. 20 is a time chart showing the deceleration transitional characteristics of the deceleration control apparatus for a vehicle according to the third exemplary embodiment of the invention;

FIGS. 21A and 21B are a flowchart illustrating control by a deceleration control apparatus for a vehicle according to a fourth exemplary embodiment of the invention;

FIGS. 22A and 22B are is a flowchart illustrating another control by the deceleration control apparatus for a vehicle according to the fourth exemplary embodiment of the invention;

FIGS. 23A and 23B are a flowchart illustrating control by a deceleration control apparatus for a vehicle according to a fifth exemplary embodiment of the invention;

FIG. 24 is a flowchart illustrating an operation for obtaining the braking force distribution ratio of the deceleration control apparatus according to the fifth exemplary embodiment of the invention;

FIG. 25 is a time chart illustrating the operation of the deceleration control apparatus according to the fifth exemplary embodiment of the invention; and

FIG. 26 is a flowchart illustrating control by a deceleration control apparatus for a vehicle according to a sixth exemplary embodiment of the invention.

### DETAILED DESCRIPTION OF THE PREFERRED EMBODIMENTS

In the following description, the present invention will be described in more detail in terms of exemplary embodiments with reference to the accompanying drawings.

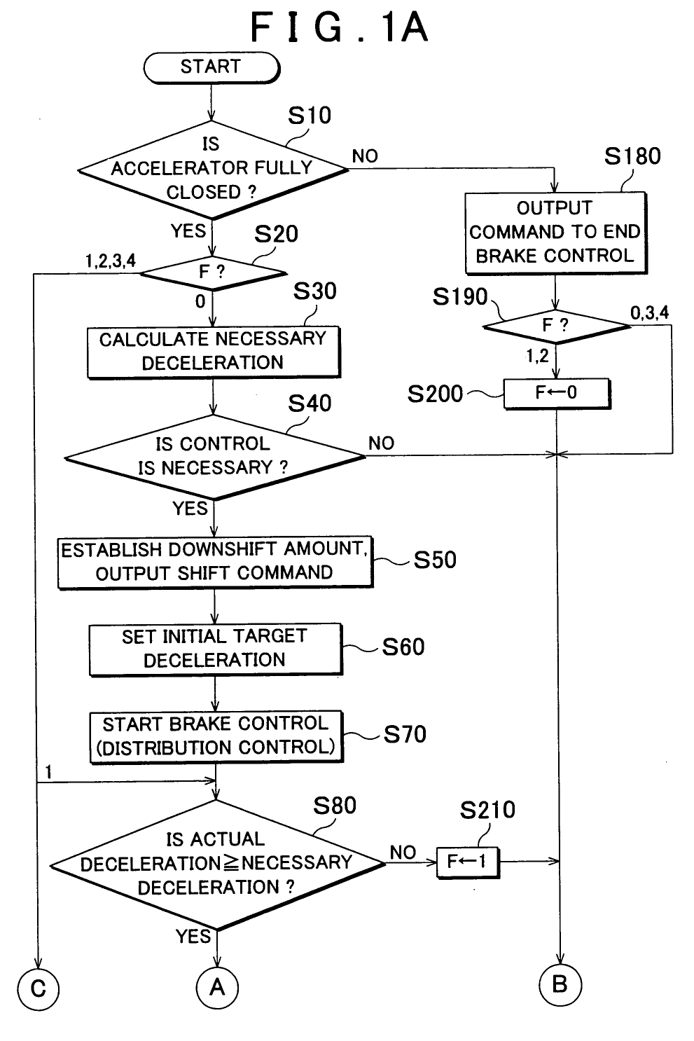

A first exemplary embodiment of the invention will now be described with reference to FIGS. 1 to 11. This exemplary embodiment relates to a deceleration control apparatus for a vehicle, which performs cooperative control between a brake system (brake devices) and an automatic transmission.

According to this exemplary embodiment, a deceleration control apparatus for a vehicle, which is capable of achieving a desired deceleration by cooperatively controlling an automatic transmission and a brake when shift point control is performed based on an upcoming corner radius, changes the front/rear wheel braking force distribution ratio of the brake system based on the total braking force and the amount of engine braking force, as well as a change in that engine braking force. In this case, the brake system is operated in response to the engine braking force to make the vehicle more stable.

As will be described in greater detail below, the structure of this exemplary embodiment presumes a transmission capable of changing speeds or speed ratios, shift determination commanding means (manual shift, shift point control), braking force controlling means (brake or MG unit), upcoming road condition detecting means for detecting the road conditions (e.g., corner radius, distance to the beginning of a corner) ahead of the vehicle, and means for controlling the shift determination commanding means and the braking force controlling means based on the detection results of the upcoming road condition detecting means. This exemplary embodiment is described with respect to an FR (front-engine-rear-wheel-drive) vehicle, in which the engine braking force acts on the rear wheel, but it may also be applied to an FF (front-engine-front-wheel-drive) vehicle.

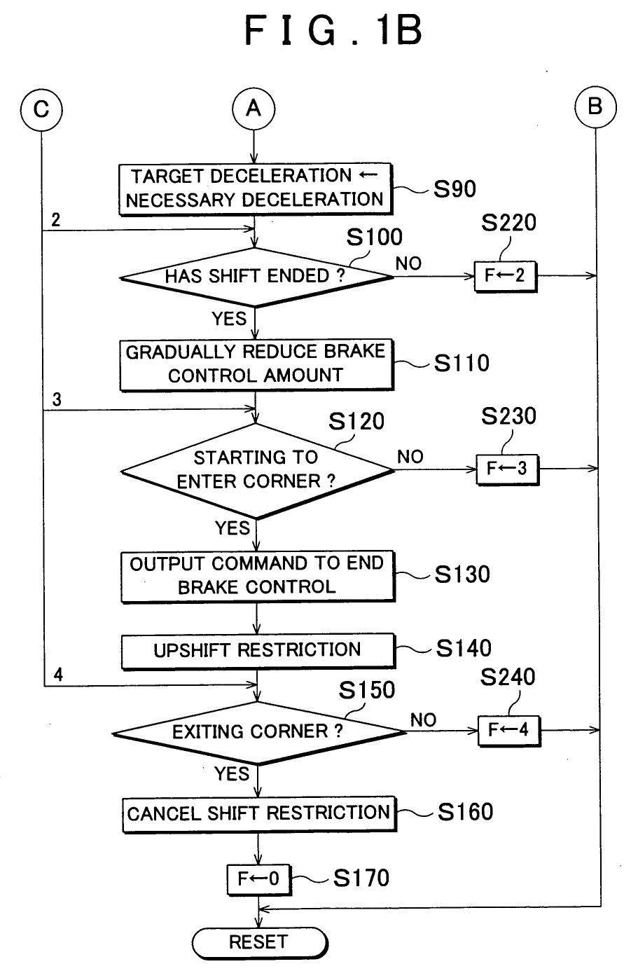

FIG. 2 shows a stepped automatic transmission 10, an engine 40, and a brake system 200. The automatic transmission 10 is capable of achieving five speeds (1st speed to 5th speed) by controlling hydraulic pressure, which is done by energizing or de-energizing electromagnetic valves 121a, 121b, and 121c. FIG. 2 shows three electromagnetic valves 121a, 121b, and 121c, but their number is not limited to this. These electromagnetic valves 121a, 121b, and 121c are driven by signals sent from a control circuit 130.

A throttle opening amount sensor 114 detects an opening amount of a throttle valve 43 disposed inside an intake passage 41 of the engine 40. An engine speed sensor 116 detects the speed of the engine 40. A vehicle speed sensor 122 detects the rotation speed an output shaft 120c of the automatic transmission 10 in proportion to the vehicle speed. A shift position sensor 123 detects a shift position of the automatic transmission 10. A pattern select switch 117 is used when selecting a shift pattern of the automatic transmission 10. An acceleration sensor 90 detects a deceleration of the vehicle. A steering angle sensor 91 detects a steering angle of the steering wheel (not shown).

A navigation system 95 basically serves to guide the host vehicle to a predetermined destination, and includes a computing and processing unit, an information storage medium, a first information detecting apparatus, and a second information detecting apparatus. The information storage medium stores information necessary for vehicle travel (such as maps, straight sections of road, curves, inclines (both uphill and downhill), and expressways). The first information detecting apparatus detects the current position of the host vehicle and the road conditions by autonomous navigation, and includes a magnetic sensor, a gyrocompass, and a steering sensor. The second information detecting apparatus also detects the current position of the host vehicle and the road conditions and the like by autonomous navigation, and includes a GPS antenna and a GPS transceiver and the like.

A road ratio μ detecting/estimating portion 92 detects or estimates the slipperiness of the road surface represented by the road surface friction coefficient μ (i.e., whether the road has a low μ.). Roads with a low μ include poor roads (including extremely rough roads and bumpy roads). That is, the road ratio μ detecting/estimating portion 92 determines whether the road has a low μ by calculating the friction coefficient μ of the road surface and determining whether that calculated friction coefficient μ is greater than a predetermined threshold value.

Alternatively, the road ratio μ detecting/estimating portion 92 can detect whether the road has a low μ without obtaining a specific value of the friction coefficient μ through calculation, but rather based on various conditions such as the rotation speed of the front wheels (not shown) (i.e., the non-driven wheel speed) detected by a front wheel speed sensor (not shown) and the rotation speed of the rear wheels (not shown) (i.e., the driven wheel speed) detected by the vehicle speed sensor 122.

The specific method for detecting or estimating whether the road ratio μ is low by the road ratio μ detecting/estimating portion 92 is not particularly limited, but can be any known method that is suitable. For example, other than the difference between the wheel speeds of the front and rear wheels, at least one of the change rate in the wheel speed, the operation history of ABS (antilock brake system), TRS (traction control system), or VSC (vehicle stability control), and the relationship between the acceleration of the vehicle and the wheel slip rate can be used to detect/estimate whether the road has a low μ.

The road ratio μ detecting/estimating portion 92 can estimate whether the road μ is low based on information (e.g., navigational information) about the road on which the vehicle will travel. Here, navigation information includes information pertaining to the road surface (such as whether the road is paved or not) stored on a storage medium (such as DVD or HD) beforehand, such as the navigation system 95, as well as information (including traffic and weather information) obtained by the vehicle itself through communication (including vehicle-to-vehicle communication and roadside-to-vehicle communication) with vehicles that were actually traveling earlier, other vehicles, or a communication center. This communication also includes road traffic information communication system (VICS) and so-called Telematics.

A manual shift determining portion 93 outputs a signal indicative of a need for a downshift (a manual downshift) or an upshift by a manual operation performed by the driver, based on a manual operation by the driver. A relative vehicle speed detecting/estimating portion 97 detects or estimates the relative speed between the host vehicle and a preceding vehicle. A vehicle-to-vehicle distance measuring portion 101 has a sensor such as a laser radar sensor or a millimeter wave radar sensor mounted on the front of the vehicle, which is used to measure the distance to the preceding vehicle.

The road gradient measuring/estimating portion 118 can be provided as a portion of a CPU 131. The road gradient measuring/estimating portion 118 can measure or estimate the road gradient based on acceleration detected by the acceleration sensor 90. Further, the road gradient measuring/estimating portion 118 can store acceleration on a level road in the ROM 133 in advance, and obtain the road gradient by comparing that stored acceleration with the actual acceleration detected by the acceleration sensor 90.

The signals indicative of the various detection results from the throttle opening amount sensor 114, the engine speed sensor 116, the vehicle speed sensor 122, the shift position sensor 123, the acceleration sensor 90, and the steering angle sensor 91 are all input to the control circuit 130. Also input to the control circuit 130 are signals indicative of the switching state of the pattern select switch 117, signals from the navigation system 95, signals indicative of the measurement results from the vehicle-to-vehicle distance measuring portion 101, signals indicative of the need to shift from the manual shift determining portion 93, and signals indicative of the detection or estimation results from both the relative vehicle speed detecting/estimating portion 97 and the road ratio μ detecting/estimating portion 92.

The control circuit 130 is a known micro-computer and includes the CPU 131, RAM 132, ROM 133, an input port 134, an output port 135, and a common bus 136. Signals from the various sensors 114, 116, 122, 123, 90, and 91, as well as signals from the pattern select switch 117, the navigation system 95, the road ratio μ detecting/estimating portion 92, the manual shift determining portion 93, the vehicle-to-vehicle distance measuring portion 101, and the relative vehicle speed detecting/estimating portion 97 are all input to the input port 134. Electromagnetic valve driving portions 138a, 138b, and 138c, as well as a brake braking force signal line L1 leading to a brake control circuit 230 are all connected to the output port 135. The brake braking force signal line L1 transmits a brake braking force signal SG1.

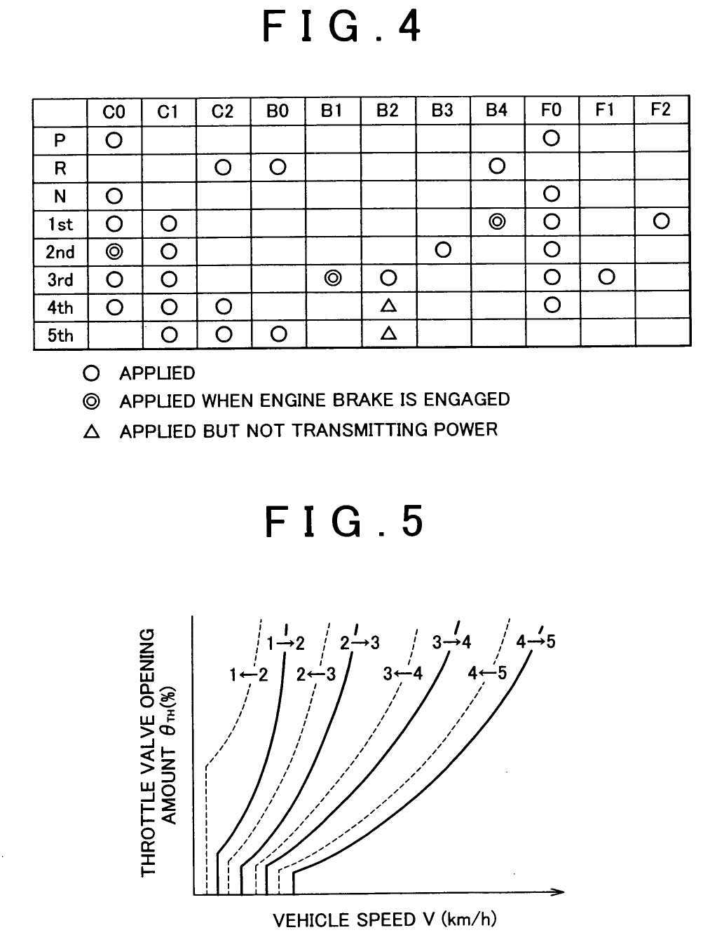

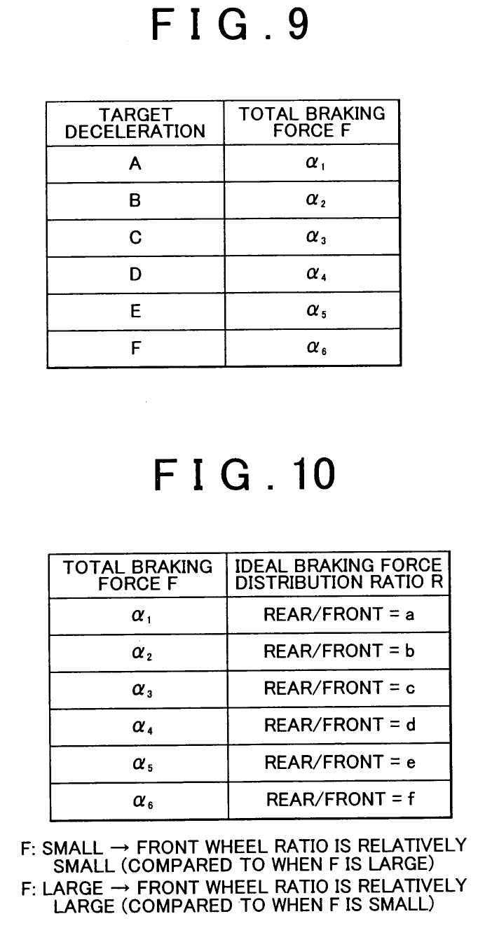

An operation (control steps) illustrated in the flowcharts in FIG. 1A, FIG. 1B, and FIG. 8, in addition to a shift map for shifting the speed of the automatic transmission 10 (FIG. 5) and an operation for shift control (not shown), are stored in the ROM 133 in advance. The control circuit 130 shifts the automatic transmission 10 based on the various control conditions that are input.

The brake system 200 is controlled by the brake control circuit 230, into which the brake braking force signal SG1 is input from the control circuit 130, so as to brake the vehicle. The brake system 200 includes a hydraulic pressure control circuit 220 and brake devices 208, 209, 210, and 211 provided on vehicle wheels 204, 205, 206, and 207, respectively. Each brake device 208, 209, 210, and 211 controls the braking force of the corresponding wheel 204, 205, 206, and 207 according to a brake hydraulic pressure which is controlled by the hydraulic pressure control circuit 220. The hydraulic pressure control circuit 220 is controlled by the brake control circuit 230.

The hydraulic pressure control circuit 220 performs brake control by controlling the brake hydraulic pressure supplied to each brake device 208, 209, 210, and 211 based on a brake control signal SG2 that ultimately determines the braking force to be applied to the vehicle. The brake control signal SG2 is generated by the brake control circuit 230 based on the brake braking force signal SG1 that the brake control circuit 230 receives from the control circuit 130 of the automatic transmission 10.

The brake control circuit 230 is a known micro-computer and includes a CPU 231, RAM 232, ROM 233, an input port 234, an output port 235, and a common bus 236. The hydraulic pressure control circuit 220 is connected to the output port 235. The operation for generating the brake control signal SG2 based on the various data included in the brake braking force signal SG1 is stored in the ROM 233 in advance. The brake control circuit 230 controls the brake system 200 (i.e., performs brake control) based on the various control conditions that are input.

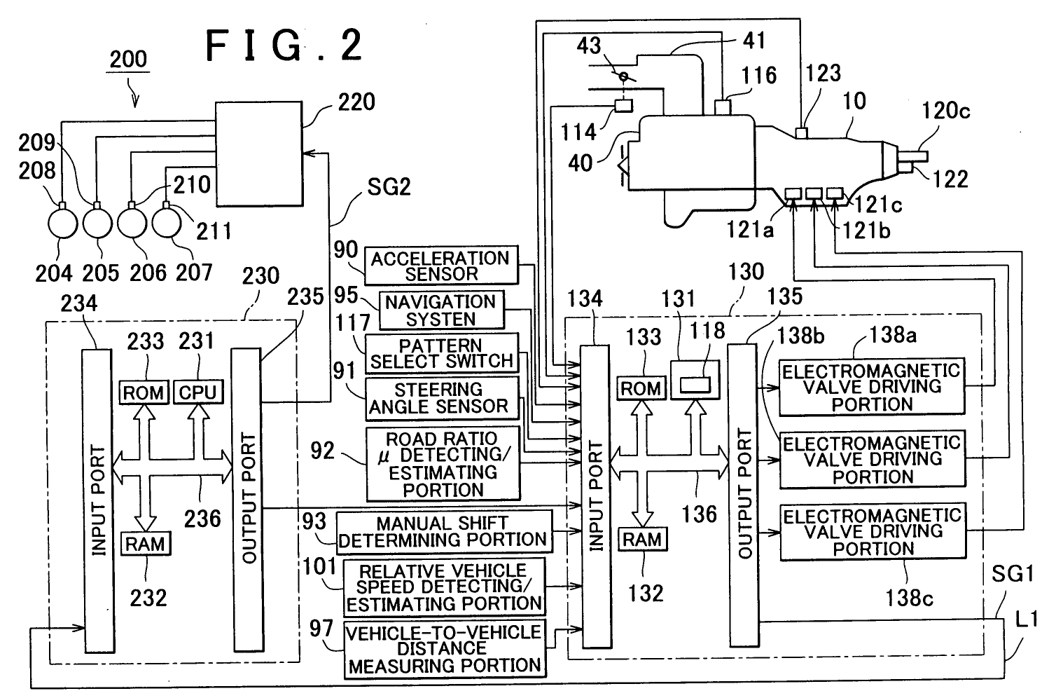

The structure of the automatic transmission 10 is shown in FIG. 3. In the drawing, output from the engine 40, i.e., an internal combustion engine which serves as the driving source for running the vehicle, is input to the automatic transmission 10 via an input clutch 12 and a torque converter 14, which is a hydraulic power transmitting device, and transmitted to driven wheels via a differential gear unit and an axle, not shown. A first motor/generator MG1 which functions as both an electric motor and a generator is arranged between the input clutch 12 and the torque converter 14.

The torque converter 14 includes a pump impeller 20 which is coupled to the input clutch 12, a turbine runner 24 which is coupled to an input shaft 22 of the automatic transmission 10, a lock-up clutch 26 for locking the pump impeller 20 and the turbine runner 24 together, and a stator 30 that is prevented from rotating in one direction by a one-way clutch 28.

The automatic transmission 10 includes a first transmitting portion 32 which switches between a high speed and a low speed, and a second transmitting portion 34 which is capable of switching between a reverse speed and four forward speeds. The first transmitting portion 32 includes an HL planetary gearset 36, a clutch C0, a one-way clutch F0, and a brake B0. The HL planetary gearset 36 includes a sun gear S0, a ring gear R0, and planetary gears P0 that are rotatably supported by a carrier K0 and in mesh with the sun gear S0 and the ring gear R0. The clutch C0 and the one-way clutch F0 are provided between the sun gear S0 and the carrier K0, and the brake B0 is provided between the sun gear S0 and a housing 38.

The second transmitting portion 34 includes a first planetary gearset 40, a second planetary gearset 42, and a third second planetary gearset 44. The first planetary gearset 40 includes a sun gear S1, a ring gear R1, and planetary gears P1 that are rotatably supported by a carrier K1 and in mesh with the sun gear S1 and the ring gear R1. The second planetary gearset 42 includes a sun gear S2, a ring gear R2, and planetary gears P2 that are rotatably supported by a carrier K2 and in mesh with the sun gear S2 and the ring gear R2. The third planetary gearset 44 includes a sun gear S3, a ring gear R3, and planetary gears P3 that are rotatably supported by a carrier K3 and in mesh with the sun gear S3 and the ring gear R3.

The sun gear S1 and the sun gear S2 are integrally coupled together, while the ring gear R1 and the carrier K2 and the carrier K3 are integrally coupled together. The carrier K3 is coupled to the output shaft 120c. Similarly, the ring gear R2 is integrally coupled to the sun gear S3 and an intermediate shaft 48. A clutch C1 is provided between the ring gear R0 and the intermediate shaft 48, and a clutch C2 is provided between the sun gear S1 and the sun gear S2, and the ring gear R0. Also, a band brake B1 is provided on the housing 38 in order to prevent the sun gear S1 and the sun gear S2 from rotating. Further, a one-way clutch F1 and a brake B2 are provided in series between the sun gear S1 and the sun gear S2, and the housing 38. The one-way clutch F1 applies when the sun gear S1 and the sun gear S2 try to rotate in the direction opposite that of the input shaft 22.

A brake B3 is provided between the carrier K1 and the housing 38, and a brake B4 and a one-way clutch F2 are provided in parallel between the ring gear R3 and the housing 38. The one-way clutch F2 applies when the ring gear R3 tries to rotate in the direction opposite that of the input shaft 22.

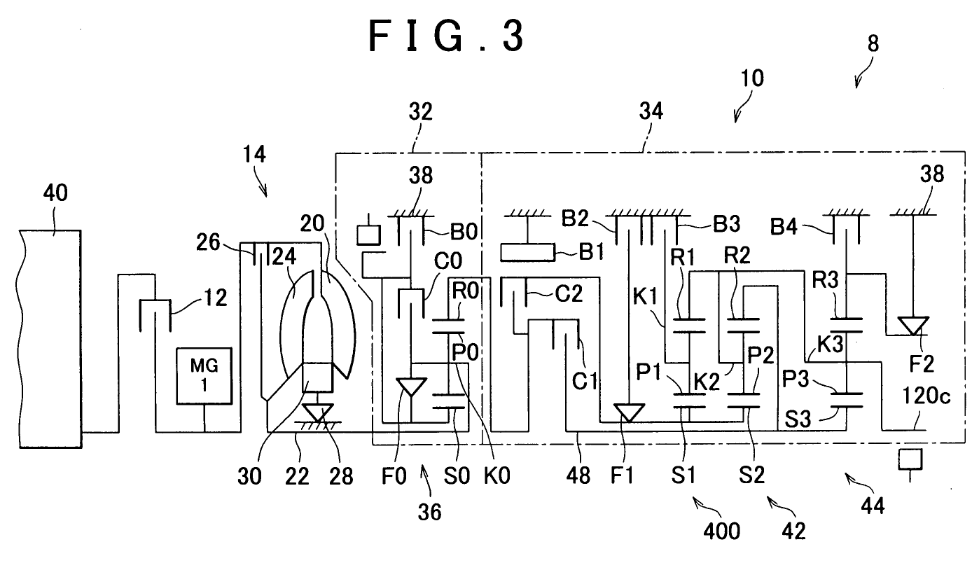

The automatic transmission 10 of the above-described structure is able to switch between any of one reverse speed and five forward speeds (1st to 5th) of successively different speed ratios, according to the table showing engagement/disengagement combinations of the automatic transmission shown in FIG. 4, for example. In the table in FIG. 4, the single circle indicates application, a blank space indicates release, a double circle (bulls-eye) indicates application when the engine brake is engaged, and a triangle indicates application but with no power being transmitted. The clutches C0 to C2 and the brakes B0 to B4 are all hydraulic friction apply devices that are applied by hydraulic actuators.

The control circuit 130 determines the gear speed of the automatic transmission 10 based on the vehicle speed V and the accelerator opening amount corresponding to the actual engine load from a shift map, such as that shown in FIG. 5, stored beforehand. The control circuit 130 then executes automatic shift control that controls the electromagnetic valves 121a to 121c in the hydraulic pressure control circuit provided in the automatic transmission 10 so as to establish the determined gear speed. The solid line in FIG. 5 is the upshift line and the broken line is the downshift line.

The operation of this exemplary embodiment will now be described with reference to FIGS. 1A, 1B, 2, and 11. The following describes to a case in which the target deceleration is greater than the deceleration obtained by the speed after a downshift (i.e., a case in which brake control is necessary).

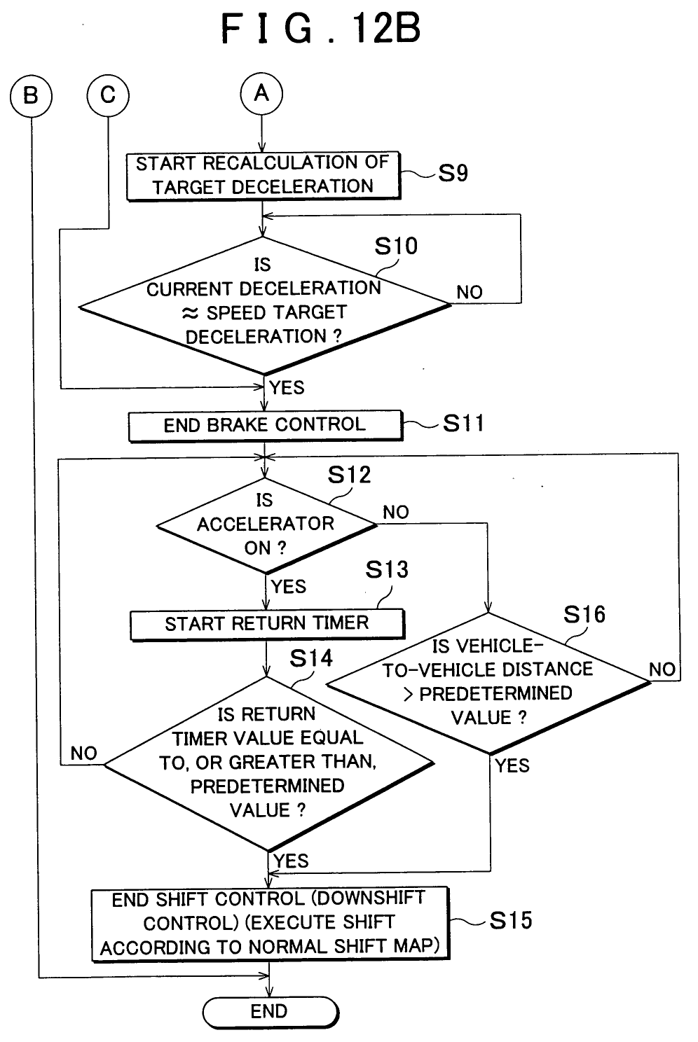

FIG. 11 is a chart illustrating the deceleration control of this exemplary embodiment. The drawing shows a control execution boundary line L, necessary deceleration 401, the shape of the road as viewed from above, input rotation speed 307 of the automatic transmission 10, accelerator opening amount 301, deceleration 303 acting on the vehicle, target deceleration 304 (initial target deceleration 304a and non-initial target deceleration 304b), deceleration (engine braking force and output shaft torque of the automatic transmission 10) 310 by the automatic transmission 10, brake control amount (deceleration by the brakes) 302, braking force 305 of the front wheels, and braking force 306 of the rear wheels.

At location (time) 407 corresponding to reference numeral A in FIG. 11, the accelerator is off (i.e., the accelerator opening is fully closed) as shown by reference numeral 301 and the brake is off (i.e., the braking force is zero) as shown by reference numeral 302.

In step S10, the control circuit 130 determines whether the accelerator is off (i.e., fully closed) based on a signal from the throttle opening sensor 114. If it is determined that the accelerator is off, then step S20 is executed. When the accelerator is fully closed (i.e., YES in step S10), it is determined that the driver intends to decelerate so the deceleration control of this exemplary embodiment is executed. If, on the other hand, it is determined that the accelerator is not off, step S180 is executed. As described above, the accelerator opening amount 301 becomes zero (i.e., fully closed) at the position (time) corresponding to reference numeral A in FIG. 11. (Reference numerals A to H at the top of FIG. 11 represent time and/or location, and thus will hereinafter simply be referred to with the prefix “point” (e.g., point A) unless otherwise specified.)

In step S20, the control circuit 130 checks a flag F. If the flag F is 0, step S30 is executed. If the flag F is 1, step S80 is executed. If the flag F is 2, step S100 is executed, and if the flag F is 3, then step S120 is executed. When this control flow is initially executed, the flag F is initially 0 so step S30 is executed.

In step S30, the control circuit 130 obtains the necessary deceleration through calculation. The necessary deceleration is the deceleration that is required for the vehicle to turn the upcoming corner at a desired lateral acceleration which is preset (i.e., for the vehicle to enter the corner at a desired speed). In FIG. 11, the necessary deceleration is indicated by reference numeral 401. In the drawing, the necessary deceleration 401 is shown in two places: the “vehicle speed” and the “vehicle deceleration G” (i.e., the deceleration acting on the vehicle).

In FIG. 11, the horizontal axis represents distance. The upcoming corner 402 is from location 403 at point E to location 404 at point G, as shown in the “shape of the road as viewed from above”. In order for the vehicle to turn the corner 402 at the desired preset lateral acceleration, the vehicle must decelerate to the target vehicle speed 406 corresponding to the radius (or curvature) of the corner 402 by the entrance 403 of the corner 402. That is, the target vehicle speed 406 is a value corresponding to the R405 of the corner 402.

A deceleration such as that shown by the necessary deceleration 401 is necessary to decelerate the vehicle from the vehicle speed at location 407 at point A, at which time it was determined in step S10 that the accelerator is fully closed, to the target vehicle speed 406 required by the entrance 403 of the corner 402. The control circuit 130 calculates the necessary deceleration 401 based on the current vehicle speed input from the vehicle speed sensor 122, as well as the distance from the current position to the entrance 403 of the corner 402 and the R405 of the corner 402 which are both input from the navigation system 95. The signal indicative of the necessary deceleration 401 is then output as the brake braking force signal SG1 from the control circuit 130 to the brake control circuit 230 via the brake braking force signal line L1.

It is conceivable that a corner may have a smaller radius than the R405 of the corner 402 in FIG. 11 (this tighter corner shall be referred to below as a “virtual corner” and is not shown in the drawing). For comparison, let us say this virtual corner starts at the same place as does the corner 402 (i.e., has an entrance at the same location as the entrance 403 of the corner 402). Since the R of this virtual corner is smaller than the R405, the vehicle must decelerate to a lower vehicle speed 406v than the target vehicle speed 406 for the corner 402 by the entrance 403 of the virtual corner. Therefore, the necessary deceleration for the virtual corner is denoted by reference number 401v which has a larger gradient than does the necessary deceleration 401, which means that a deceleration greater than the necessary deceleration 401 is required.

If the control circuit 130 determines based on the data input from the navigation system 95 that there is no corner ahead of the vehicle, then the necessary deceleration can not be obtained in step S30 and the control flow moves on to step S40.

In step S40, the control circuit 130 determines whether there is a need for the control based on, for example, the control execution boundary line L. If the coordinates of the current vehicle speed and the distance to the entrance 403 of the corner 402 are above the control execution boundary line L on the graph in FIG. 11, it is determined that the control is necessary and step S50 is executed. If, on the other hand, those coordinates are below the control execution boundary line L, it is determined that the control is unnecessary and the control flow returns.

The control execution boundary line L is a line which corresponds to the boundary of a range beyond which, due to the relationship of the current vehicle speed and the distance to the entrance 403 of the corner 402, the vehicle speed will be unable to reach a target vehicle speed 406 by the entrance 403 of the corner 402 unless a deceleration greater than the deceleration achieved by normal braking, which is set beforehand, is applied to the vehicle (i.e., beyond which the vehicle will be unable to turn the corner 402 at a desired lateral acceleration). That is, if the coordinates of the current vehicle speed and the distance to the entrance 403 of the corner 402 are above the control execution boundary line L, it is necessary to apply a deceleration greater than the deceleration achieved by normal braking, which is set beforehand, to the vehicle in order to reach the target vehicle speed 406 by the entrance 403 of the corner 402.

Therefore, when the coordinates are above the control execution boundary line L, a deceleration control corresponding to the corner radius according to this exemplary embodiment is executed (step S50), such that the target vehicle speed 406 is able to be reached by the entrance 403 of the corner 402 due to an increase in the deceleration, even if the driver is not performing a brake operation or the operation amount of the brake is relatively small (i.e., even if the footbrake is only being depressed slightly).

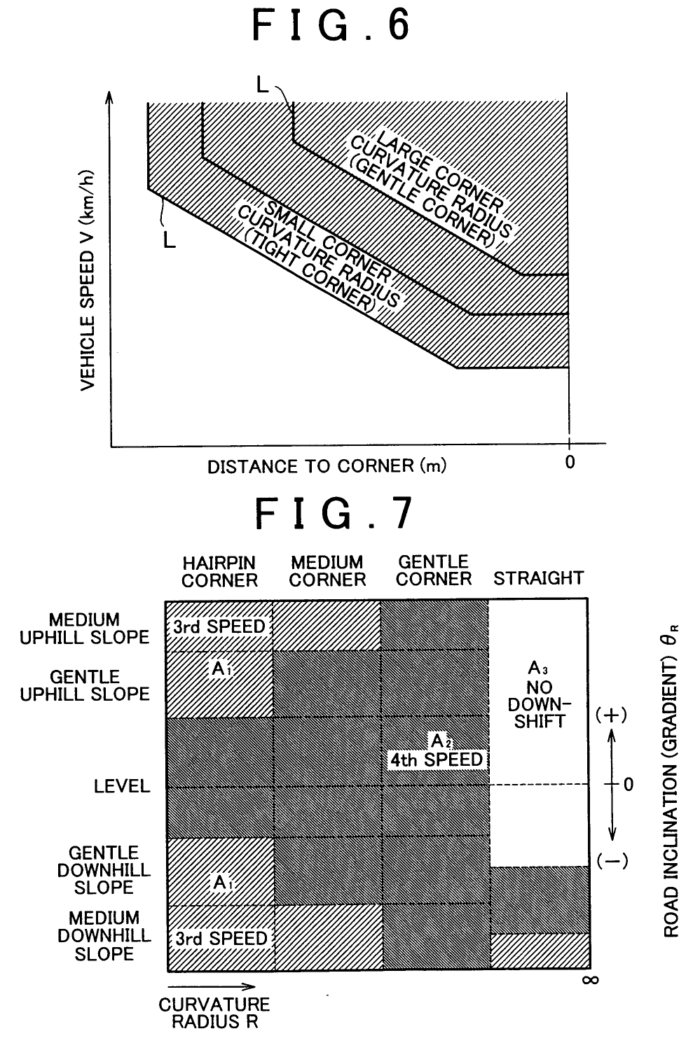

FIG. 6 is a graph illustrating the control execution boundary line L. The area with hatching represents a deceleration range calculated based on the target vehicle speed 406 determined from the curvature radius R of the corner 402 of the road ahead of the vehicle. This deceleration range is in an area where the vehicle speed is high and the distance from the corner is small. The control execution boundary line L, which represents the boundary of this deceleration range, is set to shift closer to the side where the vehicle speed is higher and the distance to the corner 402 is smaller the larger the curvature radius R of the corner 402. When the actual speed of a vehicle that is right before the corner exceeds the control execution boundary line L in FIG. 6, deceleration control corresponding to the corner radius according to this exemplary embodiment is executed.

A typical control execution boundary line conventionally used for shift point control corresponding to the corner radius can be applied as the control execution boundary line L of this exemplary embodiment. The control execution boundary line L is generated by the control circuit 130 based on data indicative of the R405 of the corner 402 and the distance to the corner 402 input from the navigation system 95.

In this exemplary embodiment, it is determined that the control is necessary because the location (location 407) corresponding to point A where the accelerator opening amount 301 is zero in FIG. 11 is above the control execution boundary line L (i.e., YES in step S40). As a result, step S50 is executed. In the example described above, the determination in step S40 of whether to execute the deceleration control corresponding to the corner radius according to the exemplary embodiment is made using the control execution boundary line L. Alternatively, however, that determination may be made based on a factor other than the control execution boundary line L.

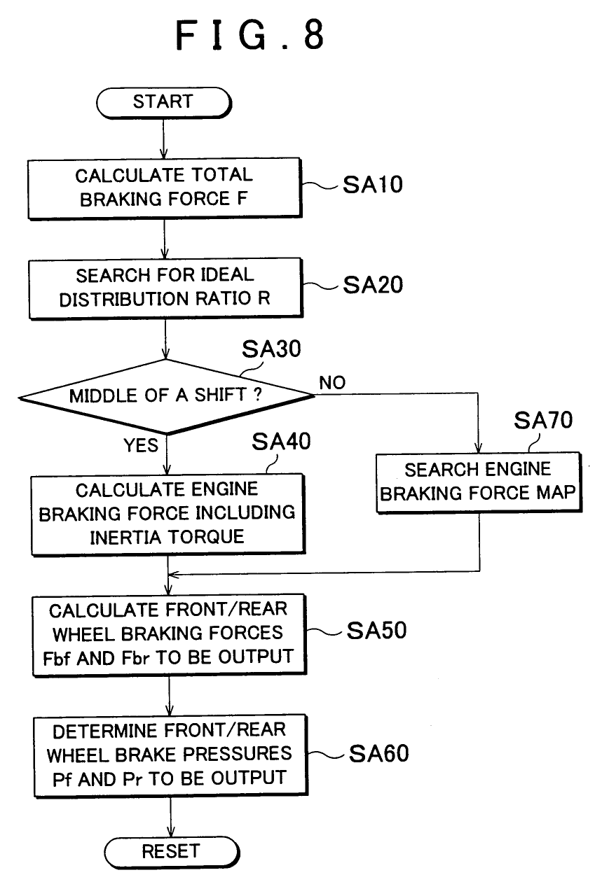

In step S50, the control circuit 130 determines the speed (i.e., downshift amount) to be selected for a downshift by shift control of the automatic transmission 10. A downshift determination map shown in FIG. 7 is used to make this determination. In FIG. 7, the speed into which the transmission is to be downshifted in the corner control is determined based on the radius (or curvature) R of the corner 402 and a road gradient θ_{R} at location A where both the accelerator and the brake are off (i.e., YES in step S10).

FIG. 7 is a downshift determination map which has a plurality of various ranges corresponding to operations of the vehicle in a two dimensional coordinate system in which the horizontal axis represents the curvature radius R of a curved section of road ahead of the vehicle and the vertical axis represents the gradient θ_{R} of the road on which the vehicle is traveling. This downshift determination map has a first downshift range A₁, a second downshift range A₂, and a no-downshift range A₃. The uphill driving force or the engine braking force when traveling downhill is set on the downshift determination map to be stronger than those produced by automatic shift control using the shift diagram in FIG. 5.

The first downshift range A₁ corresponds to i) a road with a tight curve (i.e., a small curvature radius R) and a steep (large) road gradient θ_{R}, which requires a relatively large uphill driving force or engine braking force when traveling downhill, or ii) a straight downhill road with a relatively large gradient θ_{R} that requires a relatively large engine braking force. A shift into third speed is determined when the point indicative of the curvature radius R and the road gradient θ_{R} is within range A₁.

The second downshift range A₂ corresponds to i) a road with a medium curve (i.e., in which the curvature radius R is medium) and a medium gradient θ_{R}, which requires a medium uphill driving force or engine braking force when traveling downhill, or ii) a road with a gentle curve (i.e., in which the curvature radius R is relatively large) and a relatively gradual (i.e., small) gradient θ_{R}, which requires only a relatively small increase in uphill driving force or engine braking force when traveling downhill. A shift into fourth speed is determined when the point indicative of the curvature radius R and the road gradient θ_{R} is within range A₂.

The no-downshift range A₃ corresponds to a straight uphill slope or a gradual downhill slope which does not require an increase in engine braking force. The no-downshift range A₃ ensures that a determination to downshift will not be made regardless of an operation of the vehicle when the point indicative of the curvature radius R and the road gradient θ_{R} is within the range A₃.

Here, the corner 402 is a medium-sized corner with a medium R, with a gradual downward slope at location A. In this case, the downshift determination map in FIG. 7 shows that the optimum speed is fourth speed. In step S50, the optimum speed set by the downshift determination map is compared with the current speed, and it is determined whether the current speed is a higher speed than the optimum speed. If the current speed is a higher speed than the optimum speed, it is determined that it is necessary to output a downshift by corner control so a shift command is output. If, on the other hand, the current speed is not higher than the optimum speed, it is determined that it is not necessary to output a downshift by corner control so a shift command is not output.

In this example, when the current speed at location A is fifth speed, then it is determined in step S50 that it is necessary to output a downshift into fourth speed.

When the control circuit 130 determines the speed to be selected in step S50 (fourth speed in this example) as described above, a shift command is output. That is, a downshift command (i.e., the shift command) is output from the CPU 131 of the control circuit 130 to the electromagnetic valve driving portions 138a to 138c. These electromagnetic valve driving portions 138a to 138c then energize or de-energize the electromagnetic valves 121a to 121c in response to the downshift command. As a result, the shift specified by the downshift command is performed in the automatic transmission 10.

When the control circuit 130 determines that there is a need to downshift by the shift point control according to this exemplary embodiment at a location (i.e., time) corresponding to point A in FIG. 11, the downshift command is output upon that determination (i.e., at the time of point A). Here, as shown in FIG. 11, it takes a predetermined period of time once the downshift command is output at the time of point A until the shift actually starts (i.e., the time from point A to point B in FIG. 11). As a result, the shift starts from the time at point B after the period of time has passed, at which time the engine braking force 310 from the shift starts to act on the vehicle. In FIG. 11, the portion denoted by the slanted line is the engine braking force 310. In this case, the engine braking force 310 is generated even before time B when the shift starts, from the time (point A) the accelerator is turned off. This, however, is not the deceleration from the shift, but rather the engine braking force generated when the accelerator is turned off.

As described above, the period of time from point A when the downshift command is output until time B when the shift actually starts is determined based on the type of shift (e.g., by the combination of the speed before the shift and the speed after the shift, such as 4th→3rd or 3rd→2nd). Also, when the downshift actually starts from point B, the input shaft rotation speed 307 of the automatic transmission 10 starts to increase. After step S50, step S60 is executed.

In step S60, the control circuit 130 sets an initial target deceleration 304a. This initial target deceleration 304a is the target deceleration 304 until the necessary deceleration 401 is reached. In FIG. 11, the actual deceleration 303 corresponds to line 304a that matches the actual deceleration 303 up until the point (time) when the actual deceleration 303 reaches the necessary deceleration 401 (i.e., the location corresponding to point B. That is, the initial target deceleration 304a is set so as to sweep up from the location corresponding to point A until the location corresponding to point B. The initial target deceleration 304a increases gradually at the beginning (in the initial phase in FIG. 11) of the deceleration control in order to suppress shock, and therefore an unpleasant sensation, due to sudden braking. After step S60, step S70 is executed.

In step S70, the brake control circuit 230 executes feedback control for the brakes. This feedback control for the brakes refers to controlling the braking force 302 in response to a difference between the target deceleration 304 and the actual deceleration 303. In this case, the target deceleration 304 in step S70 includes both the initial target deceleration 304a obtained in step S60, as well as the non-initial target deceleration 304b which is set in step S90 (to be described later) and then reduced in step S110.

As shown by reference numeral 302, the feedback control of the brakes starts at a location (the time) corresponding to point A when the downshift command is output. That is, a signal indicative of the target deceleration 304 (here, the initial target deceleration 304a) is output from the location (i.e., time) corresponding to point A as the brake braking force signal SG1 from the control circuit 130 to the brake control circuit 230 via the brake braking force signal line L1. Then based on the brake braking force signal SG1 input from the control circuit 130, the brake control circuit 230 generates the brake control signal SG2 and outputs it to the hydraulic pressure control circuit 220.

The hydraulic pressure control circuit 220 then generates a braking force (i.e., the brake control amount 302) as indicated by the brake control signal SG2 by controlling the hydraulic pressure supplied to the brake devices 208, 209, 210, and 211 based on the brake control signal SG2.

In the feedback control of the brake system 200 in step S70, the target value is the target deceleration 304, the control amount is the actual deceleration 303 of the vehicle, the objects to be controlled are the brakes (brake devices 208, 209, 210, and 211), the operating amount is the brake control amount 302, and the disturbance is mainly the deceleration 310 caused by the shift of the automatic transmission 10. The actual deceleration 303 of the vehicle is detected by the acceleration sensor 90 and the like.

That is, in the brake system 200, the brake braking force (i.e., the brake control amount 302) is controlled so that the actual deceleration 303 of the vehicle comes to match the target deceleration 304. That is, the brake control amount 302 is set to produce a deceleration that makes up for the difference between the deceleration 310 caused by the shift of the automatic transmission 10 and the target deceleration 304 in the vehicle. The difference of the target deceleration 304 minus the engine braking force 310 is the brake control amount 302.

In the brake control in step S70, the feedback control for the initial target deceleration 304a may instead be sweep control. That is, a (sweep control) method may be used by which the braking force is increased at a predetermined gradient. From the location (time) corresponding to point A to the location (time) corresponding to point B in FIG. 11, the braking force 302 increases at a predetermined gradient, which causes the current deceleration 303 to increase. The braking force 302 continues to increase until the current deceleration 303 reaches the necessary deceleration 401 (i.e., YES in step S80) at the time corresponding to point B.

The predetermined gradient of the initial target deceleration 403a in step S70 or the sweep control is determined by the brake braking force signal SG1 referenced at the time the brake control signal SG2 was generated. The predetermined gradient can be changed based on the accelerator return rate when the control starts (i.e., right before the vehicle reaches the location corresponding to point A in FIG. 11), which is included in the brake braking force signal SG1, and the opening amount of the accelerator before it is returned. For example, the gradient can be set large when the accelerator return rate or the opening amount of the accelerator before it is returned is large, and small when the friction coefficient μ of the road surface is low, for example, by including data indicative of the friction coefficient μ of the road surface in the brake braking force signal SG1. The predetermined gradient can also be made to change according to the vehicle speed. In this case, the predetermined gradient can be set to increase the greater the vehicle speed.

Also in step S70, the distribution of the braking force between the front and rear wheels is controlled. The control shown in FIG. 8 is executed for the control of the distribution of the braking force 305 of the front wheels and the braking force 306 of the rear wheels. The front/rear wheel braking force distribution method will now be described with reference to FIG. 8.

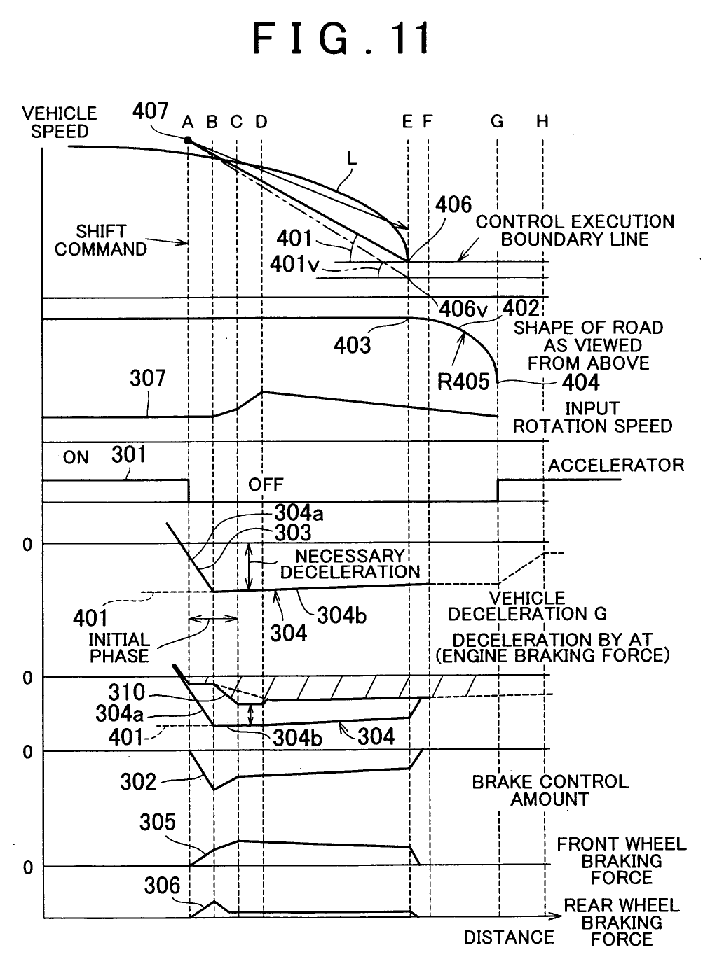

First in step SA10 in FIG. 8, the control circuit 130 obtains the amount of the total braking force F. In this case, the control circuit 130 can obtain the amount of the total braking force F by calculating it from the target deceleration 304. Alternatively, the control circuit 130 can obtain a value for the total braking force F from the total deceleration 304 based on a map such as that shown in FIG. 9 which is stored in the ROM 133 beforehand. As shown in the map in FIG. 9, the values for the target deceleration 304 and the total braking force F correspond 1 to 1. The value of the total braking force F corresponds to the braking force 302. After step SA10, step SA20 is executed.

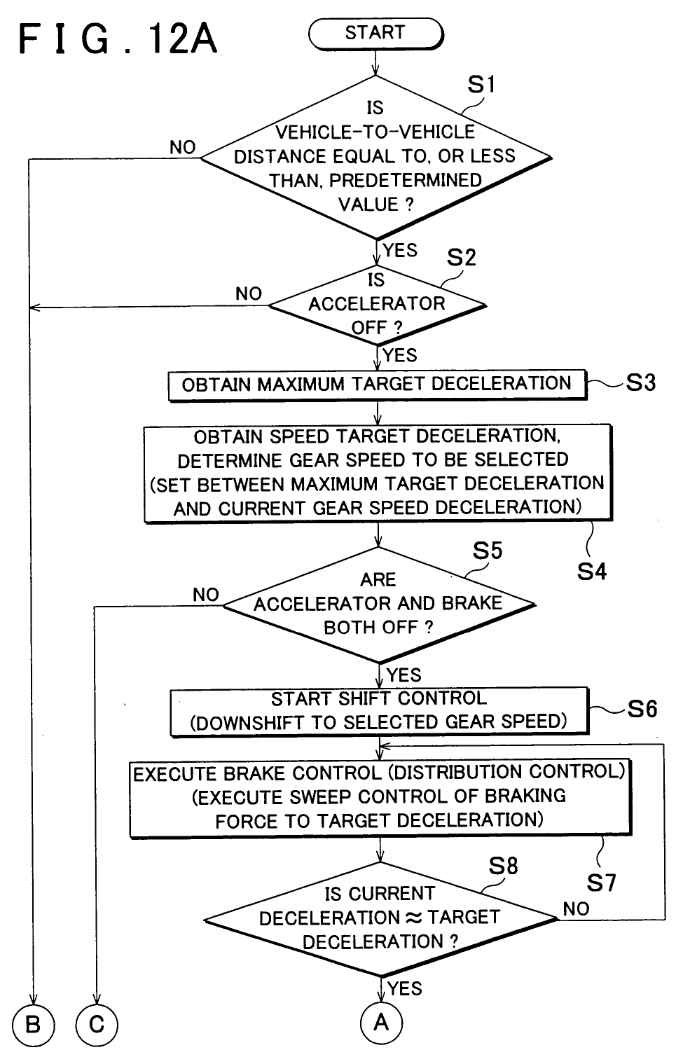

In step SA20, the control circuit 130 obtains an ideal distribution ratio R for the braking force 305 of the front wheels and the braking force 306 of the rear wheels. In this case, the control circuit 130 can obtain the ideal braking force distribution ratio R for the front and rear wheels by calculating it from the total braking force F. Alternatively, the control circuit 130 can obtain the ideal braking force distribution ratio R from the amount of the total braking force F based on a map such as that shown in FIG. 10 which is stored in the ROM 133 beforehand.

In step SA20, as a general tendency, the ratio of the braking force 305 for the front wheels in the ideal braking force distribution ratio R is relatively small when the total braking force F is relatively small, and relatively large when the total braking force F is relatively large. That is, the ideal braking force distribution ratio R is set such that braking force is applied to the front wheels at a higher ratio the larger the total braking force F. Since the effect of the forward shift in vehicle weight increases the greater the total braking force F, the ideal braking force distribution ratio R is higher at the front wheels in order to prevent the rear wheels from locking. After step SA20, step SA30 is executed.

In step SA30, the control circuit 130 determines whether the automatic transmission 10 is in the middle of a shift. The control circuit 130 can make this determination based on the input rotation speed 307 of the automatic transmission 10. As shown in FIG. 11, when the shift starts at the time of point B, the input rotation speed 307 begins to increase. This increase in the input rotation speed 307 continues until the shift ends at around point D. Because the input rotation speed 307 stops increasing when the shift ends, the determination as to whether the automatic transmission 10 is in the middle of a shift can therefore be made based on the input rotation speed 307.

Further, the control circuit 130 can determine whether the automatic transmission 10 is in the middle of a shift based on a timer (not shown). The timer is set for an amount of time established by a map (not shown) stored in the ROM 133 beforehand. This map establishes both the period of time from the output of a shift command until the shift starts and the period of time from the start of the shift until the end of the shift. If it is determined in step SA30 that the automatic transmission 10 is in the middle of a shift, step SA40 is executed. If not, step SA70 is executed.

In step S40, the control circuit 130 obtains the engine braking force 310 that includes the inertia torque. After the shift starts (after point B in FIG. 11), the engine braking force 310 that includes the inertia torque differs depending on the amount of time that has passed after the shift has started. Therefore, in step SA40 the engine braking force 310 that includes the inertia torque is obtained as a different value depending on the amount of time that has passed after the shift has started. In this case, the control circuit 130 can obtain the engine braking force 310 that includes the inertia torque during the shift through calculation. The basic concept for obtaining the engine braking force 310 that includes the inertia torque through calculation will now be described.

First, at a point prior to the start of the shift (when it is not during a shift) (i.e., at point B), the deceleration (engine braking force) from a speed (for example, fifth speed) prior to a shift appropriate for the vehicle speed at that time can be obtained. The engine braking force when a shift is not currently being performed can be obtained based on the speed and the vehicle speed.

Next, the engine braking force at the point when the shift ends (near point D, i.e., when a shift is not being performed) can be obtained based on the vehicle speed at a point before the shift started (at point B) and the speed after the shift (for example, fourth speed).

Next, the period of time from when the shift starts until the shift ends (i.e., from point B to around point D) is obtained based on the type of shift and the vehicle speed at the start of the shift (i.e., at point B). In this case, the period of time between the start of the shift and the end of the shift is set as a reference value beforehand based on the type of shift and the vehicle speed at the start of the shift (i.e., at point B). This reference shift time is used in step SA40.

As described above, once the engine braking force at the time the shift starts (at point B), the engine braking force at the time the shift ends (near point D), and the period of time between the start and end of the shift are obtained, it can be assumed that the engine braking force changes linearly from the start of the shift (at point B) until the end of the shift (near point D). Accordingly, it is possible to obtain the change over time in the engine braking force that corresponds to the line segment shown by the alternate long and two short dashes line from point B to around point D of the engine braking force 310 in FIG. 11. The inertia torque is not included in the engine braking force corresponding to the line segment shown by this alternate long and two short dashes line.

In FIG. 11, of the engine braking force 310 from point B to near point D, the portion excluding the engine braking force that corresponds to the line segment shown by the alternate long and two short dashes line from point B to near point D corresponds to the inertia torque. This inertia torque can be obtained through calculation based on the extent to which the shift operation has progressed, which is represented by a change in the input rotation speed 307.

The control circuit 130 obtains the engine braking force 310 that includes the inertia torque during a shift through calculation, as described above, by the follow procedures.

First, a virtual line segment shown by the alternate long and two short dashes line from point B to near point D of the engine braking force 310 in FIG. 11 is obtained by the method described above. Then, an engine braking force (which does not include the inertia torque) corresponding to the point when the engine braking force 310 that includes that inertia torque is obtained, is obtained on this virtual line segment.

Next, the inertia torque when the engine braking force 310 that includes the inertia torque is obtained, is obtained by the method described above. Then the sum of that inertia torque and the engine braking force (not including the inertia torque) when the engine braking force 310 that includes the inertia torque is obtained, is obtained. The engine braking force 310 that includes that inertia torque can then be obtained as that sum.

As described above, when obtaining the engine braking force 310 that includes the inertia torque during a shift, the control circuit 130 can also use a method that uses a map (not shown) stored beforehand in the ROM 133 instead of the calculation method. On that map, the value of the engine braking force 310 that includes the inertia torque is determined based on the type of shift, the vehicle speed, and the time that has passed since the start of the shift. After step SA40, step SA50 is executed.

In step SA50, the control circuit 130 can obtain the front and rear braking forces Fbf and Fbr to be output according to the following expression.
F=Fr+Ff
R=Fr/Ff
wherein F is the total braking force and R is the ideal braking force distribution ratio.
   Here, Ff is the front wheel braking force which equals the front wheel brake braking force (Fbf), and Fr is the rear wheel braking force which equals the rear wheel brake braking force (Fbr) plus the engine braking force (Fe).
   Thus,
   Fbf=F/(R+1)
   Fbr=RF/(R+1)−Fe
   Accordingly, once (F→R) and Fe have been determined, Fbf and Fbr are determined.

F above is obtained from the target deceleration 304 (step SA10 in FIG. 8), R is obtained from that F (step SA20), and Fe is obtained by steps SA40 and SA70.

Here, the front wheel braking force Fbf corresponds to the braking force 305 (FIG. 11) of the front wheel, and the rear wheel braking force Fbr corresponds to the braking force 306 of the rear wheel. After step SA50, step SA60 is executed.

In step SA60, the control circuit 130 obtains the front and rear brake hydraulic pressures Pf and Pr to be output through calculation using the following expressions.
Fbf=KfPf−Wf
Fbr=KrPr−Wr

Here, Kf is a constant determined by, for example, the capacity of the brake piston for the front wheels. Kr is a constant determined by, for example, the capacity of the brake piston for the rear wheels. Also, Wf is the reaction force (spring reaction force) of a rubber oil seal of the brake piston for the front wheels and is a known value, while Wr is the reaction force (spring reaction force) of a rubber oil seal of the brake piston for the rear wheels and is also a known value. Further, Pf and Pr can not be negative values so the actual hydraulic pressure is determined under the restriction that it must be equal to, or greater than, a predetermined value, for example.

When the control circuit 130 determines the front wheel brake hydraulic pressure Pf and the rear wheel brake hydraulic pressure Pr in step SA60, data indicative of those pressures Pf and Pr is included in the brake braking force signal SG1. This brake braking force signal SG1 is output from the control circuit 130 to the brake braking circuit 230. The front wheel braking force 305 and the rear wheel braking force 306 applied to the vehicle during brake control are both determined by the brake control signal SG2 generated by the brake control circuit 230 based on the data of the front and rear wheel brake hydraulic pressures Pf and Pr included in the brake braking force signal SG1. The hydraulic control circuit 220 then performs brake control by controlling the brake hydraulic pressures Pf and Pr supplied to each of the brake devices 208, 209, 210, and 211 based on the brake control signal SG2.

In step SA70, the control circuit 130 obtains the engine braking force 310 by referencing a map (not shown) stored in the ROM 133 beforehand. An engine braking force for each combination of speed and vehicle speed are set in this map. The control circuit 130 then obtains the engine braking force based on the speed and vehicle speed referencing that map. In this case, the control circuit 130 references the map to obtain both the engine braking force before the start of the shift (i.e., before point B in FIG. 11) based on the speed before the shift (e.g., 5th speed) and the vehicle speed, and the engine braking force after the shift ends (i.e., after around point D in FIG. 11) based on the speed after the shift (e.g., 4th speed) and the vehicle speed. After step SA70, step SA50 is executed.

From point A to point B in the example shown in FIG. 11, no deceleration (engine braking force 310) is produced at the rear wheels by a downshift, so the ratio of the brake control amount 302 on the front wheels is relatively small compared to when deceleration by a downshift is produced. Even so, from point A to point B, the percentage of the brake control amount 302 on the front wheels is somewhat larger than it is on the rear wheels by an amount corresponding to the amount of deceleration (i.e., engine braking force 310) acting on the rear wheels due to the accelerator being off. Since the braking force due to the shift of the automatic transmission 10 increases from point B, the braking force 306 of the rear wheels is reduced. When the shift ends (i.e., YES in step S100) near point D, the target deceleration 304 (or the brake control amount 302) sweeps down (step S110) and the vehicle speed decreases (the input rotation speed 307 decreases) as the vehicle nears the corner 402. As this happens, the braking force 305 of the front wheels is also gradually decreased by an amount corresponding to the decrease in the engine braking force.

Further, when the shift starts at point B, the rotation speed of certain members (such as the input rotation speed 307) increases. The front and rear wheel braking force (=distribution) can therefore be changed when this increase is detected.

Above is described the execution of the distribution control of the brakes in step S70 in FIG. 1A through the operations of steps SA10 to SA70 in FIG. 8. Steps S80 and thereafter in FIG. 1A will now be explained.

In step S80, the control circuit 130 determines whether the actual deceleration 303 is equal to, or greater than, the necessary deceleration 401. If the actual deceleration 303 is equal to, or greater than, the necessary deceleration 401, step S90 is executed. If not, step S210 is executed.

Since the actual deceleration 303 is not equal to, or greater than, the necessary deceleration 401 (i.e., NO in step S80) in the first cycle of this control flow, the flag F is set to 1 in step S210 and the control flow is reset. If accelerator is fully closed (i.e., YES in step S10) in the next cycle of the control flow, step S80 is executed because the flag F is 1 (i.e., 1 in step S20). If the condition in step S80 is not satisfied, the control flow is repeated until it is satisfied.

Once the condition in step S80 is satisfied (i.e., YES in step S80), the control flow proceeds on to step S90. In FIG. 11, the actual deceleration 303 is equal to, or greater than, the necessary deceleration 401 at the time corresponding to point B. It should be noted that even after step S80, the brake control (including the distribution control) in step S70 continues to be executed until the brake control ends in step S130.

In step S90, the control circuit 130 sets the target deceleration 304 to equal the necessary deceleration 401. That is, the sweep up range of the actual deceleration 303 (i.e., the initial target deceleration 304a) ends after the location (time) corresponding to point B in FIG. 11. The target deceleration 304 after being set in step S90 is referred to as the non-initial target deceleration 304b for the purpose of distinguishing it from the initial target deceleration 304a that was set in step S60. After step S90, step S100 is executed.

Although in this description sequential computation of the target deceleration 304 is not performed in step S90, it is possible to do so. That is, instead of executing step S90 in the manner described above, the control circuit 130 could alternatively obtain the necessary deceleration 401 through recalculation and reset the target deceleration 304 in accordance with that obtained necessary deceleration 401. After step S30, when the deceleration control (both the shift control and the brake control) starts (step S50 and step S70), the vehicle speed and the current position also change so the necessary deceleration 401 corresponding to that change can be obtained again. In this case, the target deceleration 304 can be set as a value that is the same as, or close to, that of the necessary deceleration 401 obtained here. This is because since the deceleration 303 acting on the vehicle has already reached the necessary deceleration 401 once (i.e., YES in step S80), even if the target deceleration 304 were a value that is the same as, or close to, that of the recalculated necessary deceleration 401, any shock or discomfort due to sudden braking would be relatively small.

In step S100, the control circuit 130 determines whether the shift has ended. This determination can be made according to the method described in step SA30 in FIG. 8. If the shift has not ended, the flag F is set to 2 (step S220) and the control flow is reset. If the accelerator is fully closed (i.e., YES in step S10) in the next cycle of the control flow, step S100 is executed because the flag F is 2 (i.e., 2 in step S20). If the condition in step S100 is not satisfied, the control flow is repeated until it is satisfied.

Once the condition in step S100 is satisfied (i.e., YES in step S100), the control flow proceeds on to step S110. In FIG. 11, the shift ends near point D.

In step S110, the control circuit 130 outputs a command to gradually decrease the target deceleration 304 (non-initial target deceleration 304b). At the time step S110 is executed, the shift has ended. After the shift ends, the value of the engine braking force 310 is stable and generally constant. Therefore, when the command to gradually decrease the target deceleration 304 is output, the brake control amount 302 is gradually reduced to correspond to the gradual decrease in the target deceleration 304. After step S110, step S120 is executed. In step S110, instead of outputting a command to gradually reduce the target deceleration 304, a command that is the same as the command before the shift ended may be continued to be output.

In step S120, the control circuit 130 determines whether the vehicle has entered the corner 402. The control circuit 130 makes the determination in step S120 based on data indicative of the current position of the vehicle and the location of the entrance 403 of the corner 402, which is input from the navigation system 95. If the vehicle has started to enter the corner 402, step S130 is executed. If not, step S230 is executed.

In the first cycle of the control flow, the vehicle has not entered the corner 402 (i.e., NO in step S120) so the flag F is set to 3 in step S230 and the control flow is reset. If the accelerator is fully closed (i.e., YES in step S10) in the next cycle of the control flow, step S120 is executed because the flag F is 3 (i.e., 3 in step S20). If the condition in step S120 is not satisfied, the control flow is repeated until it is satisfied.

Once the condition in step S120 is satisfied (i.e., YES in step S120), the control flow proceeds on to step S130. In FIG. 11, the vehicle enters the corner 402 at a location (time) corresponding to point E.

In step S130, the control circuit 130 ends the brake control. This is because after the vehicle enters the corner 402, the driver feels less discomfort if the braking force from the brakes does not act on the vehicle. At the end of the brake control, the braking force 302 is made to sweep down (i.e., is gradually decreased). The brake control circuit 230 is notified that the brake control is to be ended via the brake braking force signal SG1. In FIG. 11, the brake control ends at the location (time) (point E where the vehicle enters the corner) when it has been confirmed that the vehicle is entering a corner. After step S130, step S140 is executed.

In step S140, the control circuit 130 restricts an upshift from being performed. While the vehicle is cornering after entering the corner 402, an upshift into a relatively higher speed than the speed into which the transmission was downshifted in step S50 is restricted. Normally, even in shift point control for a typical corner, an upshift while cornering after entering a corner is prohibited. A downshift while cornering after entering the corner 402 is not particularly restricted should the driver desire acceleration force by a kick-down or the like. After step S140, step S150 is executed.

In step S150, the control circuit 130 determines whether the vehicle has exited the corner 402. The control circuit 130 makes this determination based on data indicative of the current position of the vehicle and the location of the exit 404 of the corner 402, which is input from the navigation system 95. If the vehicle has exited the corner 402, step S160 is executed. If not, step S240 is executed.

In the first cycle of the control flow, the vehicle has not exited the corner 402 (i.e., NO in step S150) so the flag F is set to 4 in step S240 (step S240) and the control flow is reset. If the accelerator is fully closed (i.e., YES in step S10) in the next cycle of the control flow, then step S150 is executed with the upshift restriction (step S140) still in effect because the flag F is 4 (i.e., 4 in step S20). If the condition in step S150 is not satisfied, the control flow is repeated until it is satisfied.

Once the condition in step S150 is satisfied (i.e., YES in step S150), the control flow proceeds on to step S160. In FIG. 11, the vehicle exits the corner 402 at a location (time) corresponding to point G.

In step S160, the control circuit 130 cancels the shift restriction. After step S160, step S170 is executed.

In step S170, the control circuit 130 sets the flag F to 0. After step S170, step S180 is executed.

In step S180, the control circuit 130 outputs a command to end the brake control. Step S180 is executed if it was determined in step S10 that the accelerator is not fully open (i.e., NO in step S10). The following description presumes a determination that the accelerator is not fully open.

First, a scenario will be described in which it has been determined that the accelerator is not fully open (i.e., NO in step S10) in the first cycle of the control flow (i.e., when the control is not being executed), that is, when the flag F is 0. In this case, the control (including the braking force control) has not yet started so it remains that way (step S180). After step S180, the flag is checked in step S190. In this case, the flag F is 0 (i.e., 0 in step S190) so the control flow returns.

Next, a scenario will be described in which it has been determined that the accelerator is being depressed and is therefore not fully open (i.e., NO in step S10) when the condition in step S80 or step S100 is not yet satisfied. In this case, the brake control has ended (step S180) and the flag F has been checked (step S190). Since the flag F is 1 or 2 (i.e., 1 or 2 in step S190), in this case, it is set to 0 (step S200), after which the control flow returns. Here, a downshift by the control is already being performed (step S50), but the speed into which that downshift was made is maintained and only the brake control is ended. Responsiveness to a shift is relatively poor so the speed into which the transmission was downshifted is maintained in consideration of control and the like when the accelerator is off again. In this case, if the accelerator is returned to the fully closed position again, the flag F would be 0 (i.e., 0 in step S20) so the control after step S30 would be performed again. Here, if the downshift amount in step S50 is the same as the last time, a command for the same speed will be output (i.e., no shift).

Next, when the accelerator is depressed with the condition in step S120 not yet satisfied (the flag F is 3), the brake control is ended (step S180) and the control flow returns in that state (i.e., 3 in step S190). On the other hand, when the accelerator is depressed after the vehicle has entered the corner 402 but the condition in step S150 is not yet satisfied (the flag F is 4), the brake control is ended (step S180) and the control flow returns in that state (i.e., 4 in step S190). In the next cycle of the control flow in this case, the vehicle has already entered the corner 402 so when the accelerator is fully closed (i.e., YES in step S10), the control is repeated until the vehicle to exit the corner (i.e., 4 in step S20; step S150). Unless the accelerator is depressed, the shift restriction is cancelled (step S160) at the location (time) the vehicle exits the corner 402.

When the vehicle enters the corner 402 (i.e., YES in step S120) at point E in FIG. 11, an upshift is restricted (i.e., step S140). When the vehicle comes out of the corner 402 at point G (YES in step S150), the shift restriction is cancelled (step S160). Unless the accelerator is depressed during this time, the brake control ends.

Although the above description does not discuss how a case in which a brake operation is performed by the driver when the control is being executed is handled, when the driver performs a brake operation, it is possible to have that brake operation be reflected and the brake control cancelled.

The following effects are able to be achieved according to the exemplary embodiment described above.

In addition to improved deceleration characteristics or greater deceleration, vehicle stability is also able to be ensured. In technology that cooperatively controls the transmission and the brake system, vehicle stability during braking is able to be improved by controlling the braking force of the wheels based on a change in the engine braking force.

Also, when a large deceleration is required and conventional shift point control based on a corner radius is performed using only the deceleration produced by the speed in order to achieve that required deceleration, the vehicle may become unstable as a result. Accordingly, a sufficiently large deceleration in such cases was unable to be applied to the vehicle. The deceleration produced by the speed only acts on the driven wheels, whether they be the front wheels or the rear wheels. As a result, when a large deceleration is applied to only the driven wheels, sufficient stability of the vehicle may be unable to be achieved. In this exemplary embodiment, on the other hand, deceleration is able to be produced at an appropriate front/rear wheel distribution ratio using the brakes, irrespective of the speed, so a large deceleration can be applied while still ensuring vehicle stability.

When a stepped automatic transmission alone is used to apply braking force to the vehicle (i.e., when a brake control system is not being used to apply braking force to the vehicle), it is difficult to generate the required deceleration due to the fact that the automatic transmission is stepped. Further, the engine braking force generally decreases as the vehicle speed decreases, and this is also difficult to correct. Moreover, there is little degree of freedom in the shift characteristics which makes it difficult to produce the desired initial gradient.

With this exemplary embodiment, on the other hand, brakes (with which analog control is possible) able to produce a deceleration as an analog value are used together with a stepped automatic transmission that can only produce deceleration in steps. This solves the problem that occurs when the foregoing stepped automatic transmission alone is used, and enables optimum deceleration characteristics to be obtained. Even if the distance to the entrance of the corner and the vehicle speed vary, the necessary deceleration for the specific distance and the specific vehicle speed is obtained, and that necessary deceleration is able to be applied to the vehicle reliably and smoothly using the automatic transmission and the brakes. Also, good acceleration characteristics can be obtained also at the beginning of the corner by coordinating the deceleration produced by the brakes with the deceleration produced by the speed of the automatic transmission. In this case, the distribution ratio between the front and rear wheels of the braking force produced by the brakes is made relatively larger on the non-driven wheel side by an amount equal to the amount of deceleration (engine braking force) produced by the downshift of the automatic transmission that acts on the driven wheels, which is effective for stabilizing the vehicle.

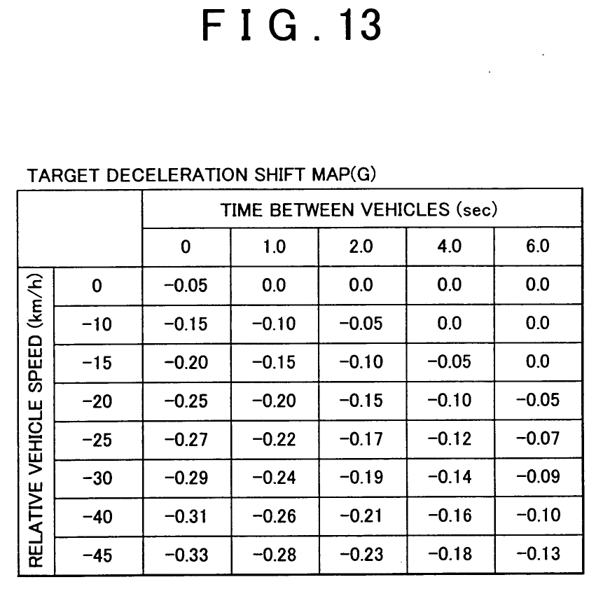

A second exemplary embodiment of the invention will now be described with reference to FIGS. 12 to 18. Descriptions of structures in the second exemplary embodiment that are the same as those in the first exemplary embodiment will be omitted.

The second exemplary embodiment provides a deceleration control that incorporates the advantages of good response and controllability offered by the brake system (i.e., the brakes), as well as the advantage of increased engine braking offered by a downshift, by performing brake control (automatic brake control) in cooperation with shift control (downshift control by an automatic transmission) when it is detected, based on vehicle-to-vehicle distance information, that the distance between vehicles is equal to, or less than, a predetermined value. In this case, this exemplary embodiment changes the front/rear wheel braking force distribution ratio of the brake system based on the total braking force as well as the amount of engine braking force and the change in that engine braking force. Here, the brake system is operated according to the engine braking force so that the vehicle becomes more stable.

Next, operation of this exemplary embodiment will be described with reference to FIGS. 12A and 12B.

First in step S1 of FIG. 12A, the control circuit 130 determines whether the distance between the host vehicle and the preceding vehicle is equal to, or less than, a predetermined value based on a signal indicative of the vehicle-to-vehicle distance input from the vehicle-to-vehicle distance measuring portion 101. If it is determined that the vehicle-to-vehicle distance is equal to, or less than, the predetermined value, then step S2 is executed. If, on the other hand, it is determined that the vehicle-to-vehicle distance is not equal to, nor less than, the predetermined value, the control flow ends.

Instead of directly determining whether the vehicle-to-vehicle distance is equal to, or less than, the predetermined value, the control circuit 130 may also indirectly determine whether the vehicle-to-vehicle distance is equal to, or less than, the predetermined value by a parameter by which it can be known that the vehicle-to-vehicle distance is equal to, or less than, the predetermined value, such as the time to collision (vehicle-to-vehicle distance/relative vehicle speed), the time between vehicles (vehicle-to-vehicle distance/host vehicle speed), or a combination of the two.

In step S2, the control circuit 130 determines whether the accelerator is off based on a signal output from the throttle opening amount sensor 114. If it is determined in step S2 that the accelerator is off, then step S3 is executed. Vehicle-following control starts from step S3. If, on the other hand, it is determined that the accelerator is not off, the control flow ends.

In step S3, the control circuit 130 obtains a target deceleration. The target deceleration is obtained as a value (deceleration) with which the relationship with the preceding vehicle comes to equal the target vehicle-to-vehicle distance or relative vehicle speed when deceleration control based on that target deceleration (to be described later) is executed in the host vehicle. The signal indicative of the target deceleration is output as a brake braking force signal SG1 from the control circuit 130 to the brake control circuit 230 via the brake braking force signal line L1.

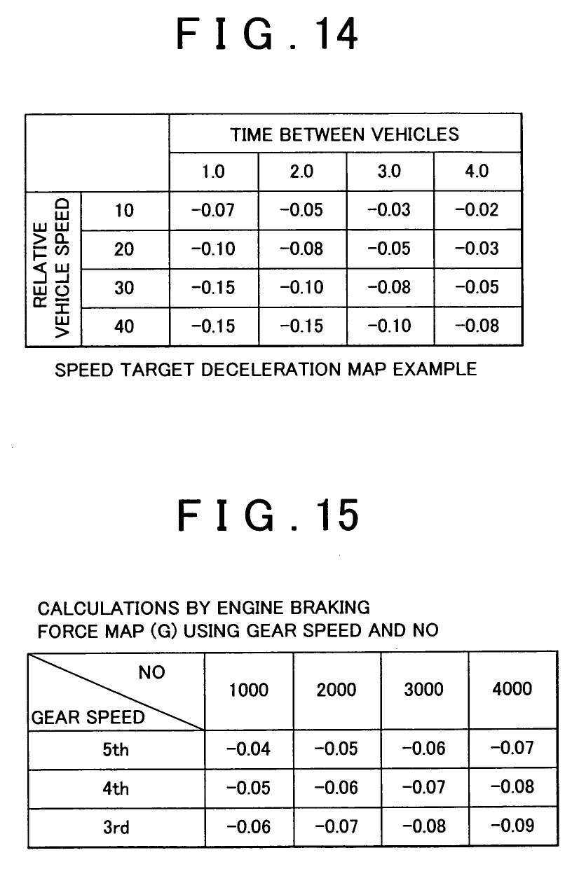

The target deceleration is obtained referencing a target deceleration map (FIG. 13) stored in the ROM 133 beforehand. As shown in FIG. 13, the target deceleration is obtained based on the relative speed (km/h) and time (sec) between the host vehicle and the preceding vehicle. Here, the time between vehicles is the vehicle-to-vehicle distance divided by the host vehicle speed, as described above.

In FIG. 13, for example, when the relative vehicle speed (here the relative vehicle speed equals the preceding vehicle speed minus the host vehicle speed) is −20 [km/h] and the time between the vehicles is 1.0 [sec], the target deceleration is −0.20 (G). The target deceleration is set to a smaller value (so that the vehicle will not decelerate) the closer the relationship between the host vehicle and the preceding vehicle is to a safe relative vehicle speed and vehicle-to-vehicle distance. That is, the target deceleration is obtained as a value that has a smaller absolute value on the upper right side of the target deceleration map in FIG. 13 the greater the distance between the host vehicle and the preceding vehicle. On the other hand, the target deceleration is obtained as a value that has a larger absolute value on the lower left side of the target deceleration map in FIG. 13 the closer the distance between the host vehicle and the preceding vehicle.

The target deceleration obtained in step S3 is referred to as the target deceleration, or more specifically, the maximum target deceleration, for before the shift control (step S6) and the brake control (step S7) are actually performed (i.e., at the starting point of the deceleration control) after the conditions to start the deceleration control (steps S1 and S2) have been satisfied. That is, because the target deceleration is obtained in real time even while the deceleration control is being executed, as will be described later, the target deceleration obtained in step S3 is referred to specifically as the maximum target deceleration in order to differentiate it from the target deceleration obtained after the brake control and shift control have actually been executed (i.e., while the brake control and shift control are being executed). After step S3, step S4 is executed.

In step S4, the control circuit 130 obtains the target deceleration produced by the automatic transmission 10 (hereinafter referred to as “speed target deceleration”), and then determines the speed to be selected for the shift control (downshift) of the automatic transmission 10 based on the speed target deceleration. The details of step S4 are described broken down into two parts ((1) and (2)) as follows.

(1) First, the speed target deceleration is obtained. The speed target deceleration corresponds to the engine braking force (deceleration) to be obtained by the shift control of the automatic transmission 10. The speed target deceleration is set to be a value equal to, or less than, the maximum target deceleration. The speed target deceleration can be obtained by any of the following three methods.

The first of the three methods for obtaining the speed target deceleration is as follows. The speed target deceleration is set in step S3 as the product of a coefficient greater than 0 but equal to, or less than, 1 to the maximum target deceleration obtained from the target deceleration map in FIG. 13. For example, when the maximum target deceleration is −0.20 G, as in the case of the example in step S3, the speed target deceleration can be set to −0.10 G, which is the product of the maximum target deceleration −0.20 G multiplied by the coefficient 0.5, for example.

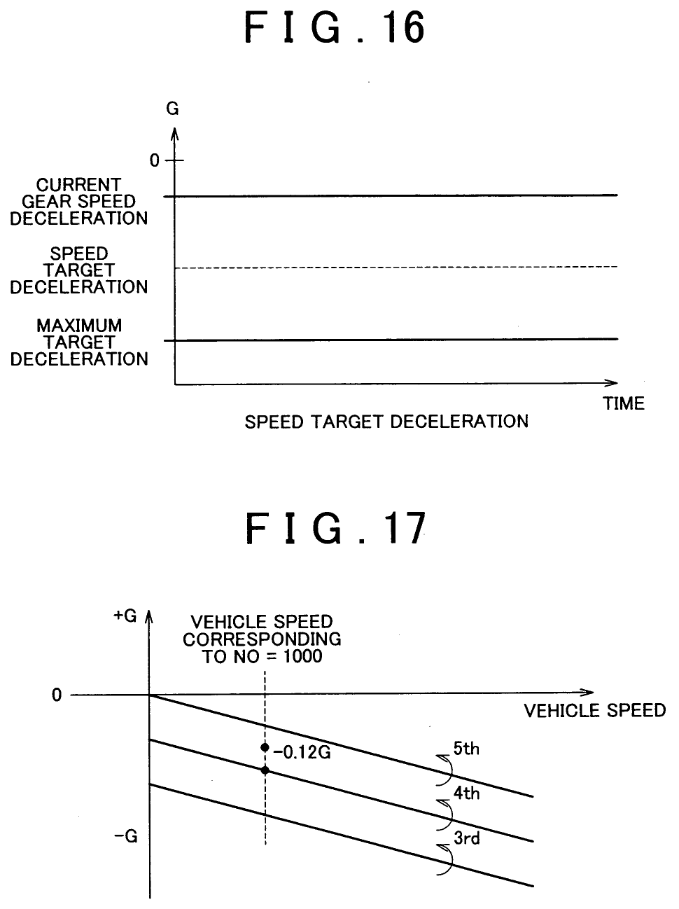

The second of the three methods for obtaining the speed target deceleration is as follows. A speed target deceleration map (FIG. 14) is stored in the ROM 133 in advance. The speed target deceleration can then be obtained referencing this speed target deceleration map in FIG. 14. As shown in FIG. 14, the speed target deceleration can be obtained based on the relative vehicle speed [km/h] and the time [sec] between the host vehicle and the preceding vehicle, just like the target deceleration in FIG. 13. For example, if the relative vehicle speed is −20 [km/h] and the time between vehicles is 1.0 [sec], as in the case of the example in step S3, a speed target deceleration of −0.10 G can be obtained. As is evident from FIGS. 13 and 14, when i) the relative vehicle speed is high so that the vehicles suddenly come close to one another, ii) the time between vehicles is short, or iii) the vehicle-to-vehicle distance is short, the vehicle-to-vehicle distance must be appropriately established early on, so the deceleration must be made larger. This also results in a lower speed being selected in the above-described situation.

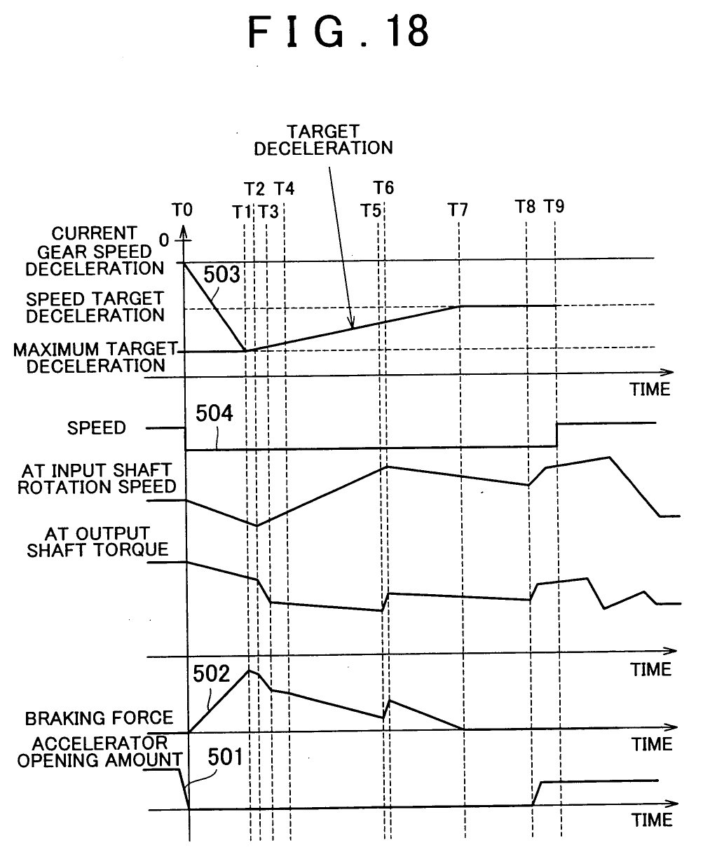

The third of the three methods for obtaining the speed target deceleration is as follows. First, the engine braking force (deceleration G) when the accelerator is off in the current gear speed of the automatic transmission 10 is obtained (hereinafter simply referred to as the “current gear speed deceleration”). A current gear speed deceleration map (FIG. 15) is stored in advance in the ROM 133. The current gear speed deceleration (deceleration) can be obtained referencing this current gear speed deceleration map in FIG. 15. As shown in FIG. 15, the current gear speed deceleration can be obtained based on the gear speed and the rotation speed NO of the output shaft 120c of the automatic transmission 10. For example, when the current gear speed is 5th speed and the output rotation speed is 1000 [rpm], the current gear speed deceleration is −0.04 G.

The current gear speed deceleration may also be a value obtained from the current gear speed deceleration map, which is corrected according to the situation, for example, according to whether an air conditioner of the vehicle is being operated, whether there is a fuel cut, and the like. Further, a plurality of current gear speed deceleration maps, one for each situation, may be provided in the ROM 133, and the current gear speed deceleration map used may be switched according to the situation.

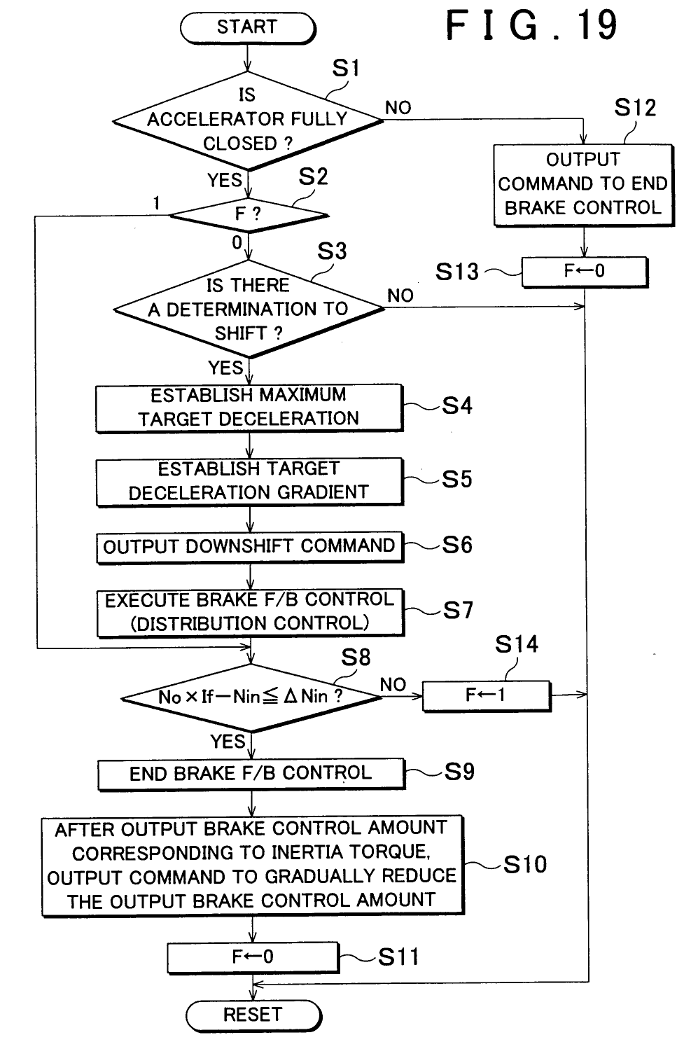

Next, the speed target deceleration is set as a value between the current gear speed deceleration and the maximum target deceleration. That is, the speed target deceleration is obtained as a value that is larger than the current gear speed deceleration but equal to, or less than, the maximum target deceleration. One example of the relationship between the speed target deceleration, the current gear speed deceleration, and the maximum target deceleration is shown in FIG. 16.

The speed target deceleration can be obtained by the following expression.
speed target deceleration=(maximum target deceleration−current gear speed deceleration)×coefficient+current gear speed deceleration
In the above expression, the coefficient is a value greater than 0 but equal to, or less than, 1.

In the above example, the maximum target deceleration is −0.20 G and the current gear speed deceleration is −0.04 G When calculated with a coefficient of 0.5, the speed target deceleration is −0.12 G.

As described above, in the first to third methods for obtaining the speed target deceleration, a coefficient is used. The value of this coefficient, however, is not obtained theoretically, but is a suitable value that is able to be set appropriately from the various conditions. That is, in a sports car, for example, a relatively large deceleration is preferable when decelerating, so the coefficient can be set to a large value. Also, in the same vehicle, the value of the coefficient can be variably controlled according to the vehicle speed or the gear speed. In a vehicle in which a sport mode (which aims to increase the vehicle response to an operation by the driver so as to achieve crisp and precise handling), a luxury mode (which aims to achieve a relaxed and easy response to an operation by the driver), and an economy mode (which aims to achieve fuel efficient running) are available, when the sport mode is selected, the speed target deceleration is set so that a larger speed change occurs than would occur in the luxury mode or the economy mode.

After being obtained in step S4, the speed target deceleration is not reset until the deceleration control ends. That is, the speed target deceleration is set so that, once it is obtained at the starting point of the deceleration control (i.e., the point at which the shift control (step S6) and the brake control (step S7) actually start), it is the same value until the deceleration control ends. As shown in FIG. 16, the speed target deceleration (the value shown by the broken line) is a constant value over time.

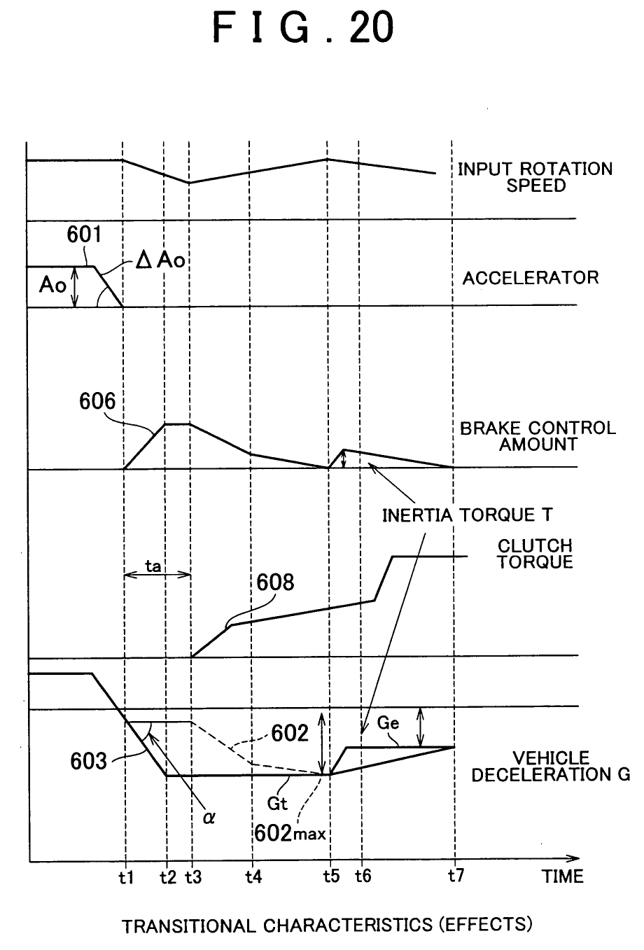

(2) Next, the speed to be selected during the shift control of the automatic transmission 10 is determined based on the speed target deceleration obtained in part (1) above. Vehicle characteristic data indicative of the deceleration G at each vehicle speed in each gear speed when the accelerator is off, such as that shown in FIG. 17, is stored in advance in the ROM 133.

Here, assuming a case in which the output rotation speed is 1000 [rpm] and the speed target deceleration is −0.12 G, just as in the example given above, the gear speed corresponding to the vehicle speed when the output speed is 1000 [rpm] and the deceleration is closest to the speed target deceleration of −0.12 G is 4th speed, as can be seen in FIG. 17. Accordingly, in the case of the above example, it would be determined in step S4 that the gear speed to be selected is 4th speed.

Here, the gear speed that would achieve a deceleration closest to the speed target deceleration is selected as the gear speed to be selected. Alternatively, however, the gear speed to be selected may be a gear speed that would achieve a deceleration which is both equal to, or less than, (or equal to, or greater than) the speed target deceleration, and closest to the speed target deceleration. After step S4, step S5 is executed.

In step S5, the control circuit 130 determines whether the accelerator and the brake are off. In step S5, when the brake is off, it means that the brake is off because a brake pedal (not shown) is not being operated by the driver. This determination is made based on output from a brake sensor (not shown) that is input via the brake control circuit 230. If it is determined in step S5 that both the accelerator and the brake are off, step S6 is executed. If, on the other hand, it is not determined that both the accelerator and the brake are off, step S11 is executed.

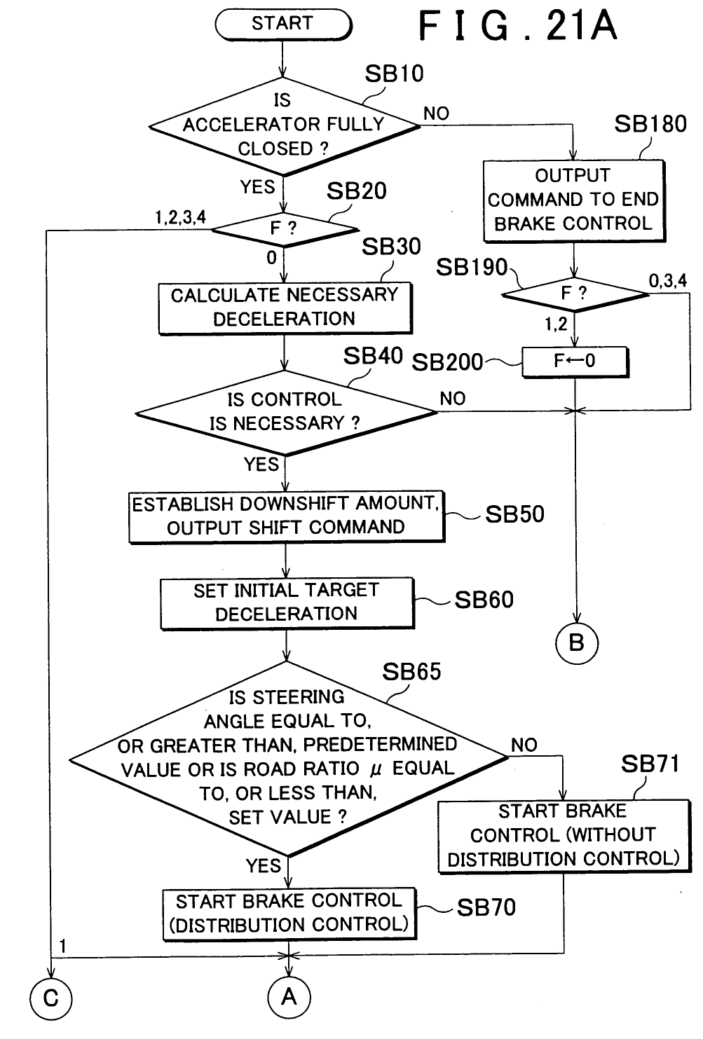

FIG. 18 is a time chart illustrating the deceleration control of this exemplary embodiment. The drawing shows the current gear speed deceleration, the speed target deceleration, the maximum target deceleration, the speed of the automatic transmission 10, the rotation speed of the input shaft of the automatic transmission 10 (AT), the torque of the output shaft of the AT, the braking force, and the accelerator opening amount.

At time T0 in FIG. 18, the brake is off (i.e., braking force equals zero), as shown by reference numeral 502, and the accelerator is off (i.e., the accelerator opening amount is zero with the accelerator being fully closed), as shown by reference numeral 501. At time T0, the current deceleration (deceleration) is the same as the current gear speed deceleration, as shown by reference numeral 503.

In step S6, the control circuit 130 starts the shift control. That is, the automatic transmission 10 is shifted to the selected gear speed (4th speed in this example) that was determined in step S4. The automatic transmission 10 is downshifted by the shift control at time T0 in FIG. 18, as shown by reference numeral 504. As a result, the engine braking force increases, so the current deceleration 503 starts to increase from time T0. After step S6, step S7 is executed.

In step S7, the brake control circuit 230 starts the brake control. That is, the braking force is gradually increased (sweep control) at a predetermined gradient until the target deceleration. From time T0 to time T1 in FIG. 18, the braking force 502 increases at a predetermined gradient, which results in an increase in the current deceleration 503. The braking force 502 continues to increase until the current deceleration 503 reaches the target deceleration at time T1 (step S8).

In step S7, the brake control circuit 230 generates the brake control signal SG2 based on the brake braking force signal SG1 input from the control circuit 130, and outputs that brake control signal SG2 to the hydraulic pressure control circuit 220. As described above, the hydraulic pressure control circuit 220 generates the braking force 502 as indicated by the brake control signal SG2 by controlling the hydraulic pressure supplied to the brake devices 208, 209, 210, and 211 based on the brake control signal SG2.

The predetermined gradient in step S7 is determined by the brake braking force signal SG1 which is referenced when generating the brake control signal SG2. The predetermined gradient can be changed based on the friction coefficient μ of the road surface, the accelerator return rate at the start of the control (immediately before time T0 in FIG. 18), or the opening amount of the accelerator before it is returned, which are included in the brake braking force signal SG1. For example, the gradient (slope) is set small when the friction coefficient μ of the road surface is small and large when the accelerator return rate or the opening amount of the accelerator before it is returned is large.

Instead of a method that increases the braking force 502 at a predetermined gradient, as described above, feedback control of the braking force 502 applied to the vehicle can be performed based on the difference between the current deceleration 503 and the target deceleration so that the current deceleration 503 becomes the target deceleration. Further, the braking force 502 by the brake control may be determined taking into account a time differential value of the rotation speed of the input shaft of the automatic transmission 10 and a shift inertia torque amount determined by the inertia.

Here, both the maximum target deceleration obtained in step S3 and the target deceleration obtained again in step S9, which will be described later, are included in the “target deceleration” in step S7. The brake control of step S7 continues to be executed until it is ended in step S11.

The distribution of the braking force of the front and rear wheels is also controlled in step S7. The method shown in FIG. 8, which is similar to that of the first exemplary embodiment, can be used for controlling the distribution of the braking force of the front wheels with respect to the braking force of the rear wheels. The value of the total braking force F in step SA10 in FIG. 8 corresponds to the braking force 502 in the second exemplary embodiment. After step S7, step S8 is executed.

In step S8, the control circuit 130 determines whether the current deceleration 503 is the target deceleration. If it is determined that the current deceleration 503 is the target deceleration, then step S9 is executed. If, on the other hand, it is determined that the current deceleration 503 is not the target deceleration, the process returns to step S7. Because the current deceleration 503 does not reach the target deceleration until time T1 in FIG. 18, the braking force 502 increases at a predetermined gradient in step S7 until then.

Then in step S9, the target deceleration is obtained again, as shown in FIG. 12B. The control circuit 130 obtains the target deceleration referencing the target deceleration map (FIG. 13), just as in step S3. The target deceleration is set based on the relative vehicle speed and the vehicle-to-vehicle distance, as described above. Because the relative vehicle speed and the vehicle-to-vehicle distance change when the deceleration control (i.e., both the shift control and the brake control) starts, the target deceleration is obtained in real time in response to that change.

When the target deceleration is obtained in real time in step S9, the braking force 502 is applied to the vehicle such that the current deceleration 503 matches the target deceleration by the brake control that is continuing from when it was started in step S7 (see steps S7 and S8).

The operation to obtain the target deceleration in step S9 continues to be performed until the brake control ends in step S11. The brake control continues (steps S10 and S11) until the current deceleration 503 matches the speed target deceleration, as will be described later. Because the current deceleration 503 is controlled to match the target deceleration (steps S7 and S8), as described above, the operation to obtain the target deceleration in step S9 continues until the obtained target deceleration matches the speed target deceleration.

At the time that step S9 is executed, the vehicle speed of the host vehicle is less, by the amount that the deceleration control has already been performed, than it was at the time that step S3 was performed before the start of the deceleration control. From this, the target deceleration obtained in order to achieve the target vehicle-to-vehicle distance and relative vehicle speed usually becomes, in step S9, a value smaller than the maximum target deceleration obtained in step S3.

From time T1 to time T7 in FIG. 18, the operation of obtaining the target deceleration in real time and applying the braking force 502 such that the current deceleration 503 matches that target deceleration is repeated. During that time, however, as a result of the brake control being continued, the target deceleration repeatedly obtained in step S9 gradually decreases. In response to this decrease in the value of the target deceleration, the braking force 502 applied by the brake control also gradually decreases, such that the current deceleration 503 gradually decreases while substantially matching that target deceleration. After step S9, step S10 is executed.

In step S10, the control circuit 130 determines whether the current deceleration 503 matches the speed target deceleration. If it is determined that the current deceleration 503 matches the speed target deceleration, the brake control ends (step S11) and this fact is transmitted to the brake control circuit 230 by the brake braking force signal SG1. If, on the other hand, the current deceleration 503 does not match the speed target deceleration, the brake control does not end. Since the current deceleration 503 matches the speed target deceleration at time T7 in FIG. 18, the braking force 502 applied to the vehicle becomes zero (i.e., brake control ends).

In step S12, the control circuit 130 determines whether the accelerator is on. If the accelerator is on, step S13 is executed. If not, step S16 is executed. In the example in FIG. 18, it is determined that the accelerator is on at time T8.

In step S13, a return timer is started. In the example in FIG. 18, the return timer starts from time T8. After step S13, step S14 is executed. The return timer (not shown) is provided in the CPU 131 of the control circuit 130.

In step S14, the control circuit 130 determines whether a count value of the return timer is equal to, or greater than, a predetermined value. If the count value is not equal to, nor greater than, the predetermined value, the process returns to step S112. If the count value is equal to, or greater than, the predetermined value, the process proceeds on to step S15. In the example shown in FIG. 18, the count value becomes equal to, or greater than, the predetermined value at time T9.

In step S15, the control circuit 130 ends the shift control (downshift control) and returns the automatic transmission 10 to the speed determined based on the accelerator opening amount and the vehicle speed according to a normal shift map (shift line) stored beforehand in the ROM 133. In the example shown in FIG. 18, the shift control ends at time T9, at which time an upshift is executed. When step S15 is executed, the control flow ends.

In step S16, the control circuit 130 determines whether the vehicle-to-vehicle distance exceeds a predetermined value. Step S16 corresponds to step S1. If it is determined that the vehicle-to-vehicle distance does exceed the predetermined value, step S15 is then executed. If it is determined that the vehicle-to-vehicle distance does not exceed the predetermined value, the process returns to step S12.

The foregoing exemplary embodiment enables the following effects to be achieved. In addition to improved deceleration characteristics or greater deceleration, vehicle stability is also able to be ensured. In technology that cooperatively controls the transmission and the brake system, vehicle stability during braking is improved by controlling the braking force of the wheels based on a change in the engine braking force. The deceleration produced by the speed (i.e., the engine braking force) acts only on the driven wheels, whether they be the front wheels or the rear wheels. As a result, when a large deceleration produced by the speed is applied only to the driven wheels, sufficient stability of the vehicle may be unable to be achieved. In this exemplary embodiment, on the other hand, deceleration using the brakes is able to be produced at an appropriate front/rear wheel distribution ratio in consideration of the deceleration produced by the speed, so vehicle stability is able to be ensured.

According to this exemplary embodiment, the speed target deceleration is set so as to be between the current gear speed deceleration and the maximum target deceleration (step S4). That is, the deceleration produced by the engine braking force obtained from the downshift (shift control) into the selected gear speed is set so as to be between the engine braking force of the speed before the start of the deceleration control (i.e., the current gear speed deceleration) and the maximum target deceleration (step S4). As a result, even when deceleration control in which the brake control and shift control are performed simultaneously in cooperation with one another is executed (steps S6 and S7), the deceleration is not excessive so no sense of discomfort is imparted to the driver. In addition, even when the vehicle-to-vehicle distance and the relative vehicle speed have reached their respective target values and the brake control has ended (step S11), the engine brake from the downshift continues to be effective so hunting of the brake control due to an increase in vehicle speed (particularly when on a downward slope) following the end of the brake control (step S11) is able to be effectively suppressed.

Also according to this exemplary embodiment, from time T1 to time T7 in FIG. 18 after the current deceleration 503 matches the maximum target deceleration (step S8), the current deceleration 503 gradually decreases while substantially matching the target deceleration calculated in real time. Then at the point when the target deceleration (the same as the current deceleration 503 in this case) matches the speed target deceleration, the brake control ends, as shown in steps S10 and S11. That is, the brake control ends when the target deceleration calculated in real time matches the speed target deceleration (i.e., the deceleration after the downshift control). In other words, the brake control does not continue until the target deceleration (the current deceleration 503 in this case) returns to the deceleration that it was at time T0 when the deceleration control started (i.e., returns to the current gear speed deceleration).

If the deceleration control were to be performed by the brake control alone, i.e., without performing the shift control, it would be necessary to continue the brake control until the target deceleration returned to near the current gear speed deceleration and the target vehicle-to-vehicle distance and relative vehicle speed could be realized by the current gear speed deceleration alone. In contrast, because in this exemplary embodiment the shift control and the brake control are performed simultaneously in cooperation with one another, the brake control can be ended when the target deceleration substantially matches the deceleration achieved by the shift control (i.e., the speed target deceleration) and the target vehicle-to-vehicle distance and relative vehicle speed can be achieved by the deceleration achieved by the shift control alone. As a result, in this exemplary embodiment, the brake control can be ended in a shorter period of time, which ensures durability of the brakes (i.e., reduces brake fade and wear on the brake pads and discs).

Further in this exemplary embodiment, the brake control ends when the target deceleration (i.e., the current deceleration 503 in this case) matches the speed target deceleration (i.e., the deceleration after the downshift control), and deceleration control with only the shift control is performed from that point (steps S10 and S11; time T7 in FIG. 18). As a result, deceleration control is performed by only the shift control while the current deceleration 503 substantially matches the deceleration after the shift control (i.e., the deceleration produced by the engine braking force), which enables a smooth transition to the deceleration produced by the engine braking force.

As described above, the brake control ends when the target deceleration substantially matches the speed target deceleration (i.e., the deceleration produced by the engine braking force after the shift control). The shift control, on the other hand, ends either after a predetermined period of time has passed after the accelerator has been turned on (steps S12 and S13) after the brake control ends (step S11) or when the vehicle-to-vehicle distance exceeds a predetermined value (step S16) after the brake control ends. In this way, by making the conditions for ending (i.e., returning from) the brake control different from those for ending (i.e., returning from) the shift control, the brake control can be ended in a short period of time, thus helping to ensure durability of the brakes. Also, since the shift control does not end unless the vehicle-to-vehicle distance exceeds the predetermined value, the engine brake continues to be effective.

The foregoing first and second exemplary embodiments describe shift point control based on the corner radius of an upcoming corner, the road gradient, and the distance to a preceding vehicle. However, during shift point control which selects the optimum speed based on a factor other than those described above, e.g., the road ratio μ, etc., a deceleration control apparatus for a vehicle that achieves a desired deceleration by cooperatively controlling an automatic transmission and the brakes can also operate the brake system in accordance with the engine braking force so that the vehicle becomes more stable by changing the front/rear wheel braking force distribution ratio in the brake system based on the total braking force and the amount of engine braking force, as well as a change in that engine braking force.

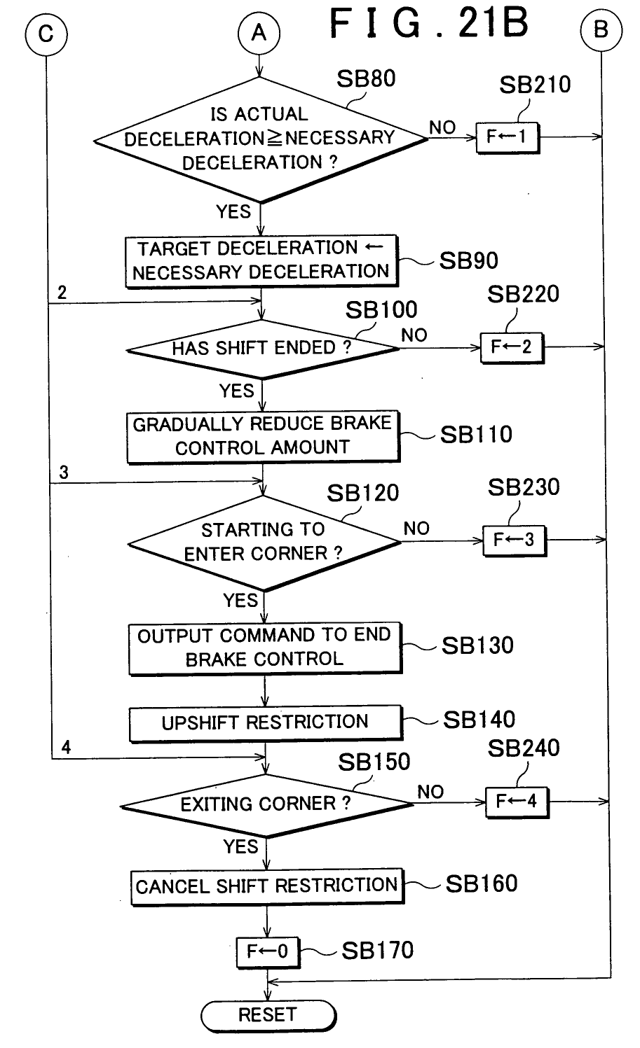

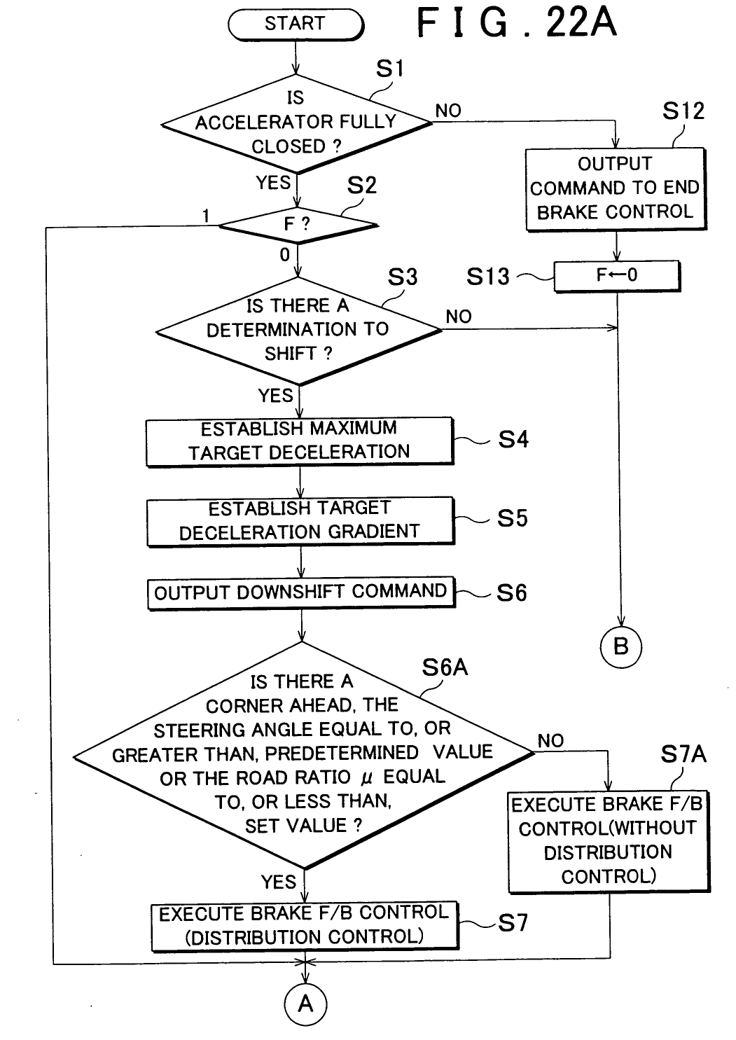

A third exemplary embodiment of the invention will now be described with reference to FIGS. 19 to 20. Descriptions of structures in the third exemplary embodiment that are the same as those in the first exemplary embodiment will be omitted.

According to the third exemplary embodiment, an apparatus for cooperatively controlling a brake system (including a brake and motor/generator) and an automatic transmission (either stepped or step-less) when a manual downshift is performed changes the front/rear wheel braking force distribution ratio in the brake system based on the total braking force and the amount of engine braking force, as well as a change in that engine braking force. A manual downshift in this case refers to a downshift that is performed manually by the driver when an increase in engine braking force is desired.

Operation of the third exemplary embodiment will next be described with reference to FIGS. 19 and 20. FIG. 19 is a flowchart showing the control flow of the third exemplary embodiment. FIG. 20 is a time chart to help explain the exemplary embodiment. The input rotation speed of the automatic transmission 10, accelerator opening amount, brake control amount, clutch torque, and deceleration (G) acting on the vehicle are all indicated in the drawing.

In FIG. 19, it is determined by the control circuit 130 in step S1 whether the accelerator (i.e., the throttle opening amount) is fully closed based on the detection results of the throttle opening amount sensor 114. If the accelerator is fully closed (i.e., YES in step S1), it is determined, when there is a shift, that the shift is intended to engage the engine brake. Therefore, the brake control of the exemplary embodiment is continued in steps S2 onward. In FIG. 20, the accelerator opening amount is fully closed at time t1, as denoted by reference numeral 601.

If, on the other hand, it is determined in step S1 that the accelerator is not fully closed (i.e., NO in step S1), a command is output to end the brake control of the exemplary embodiment (step S12). When the brake control is not being executed, this state is maintained. Next in step S13, a flag F is reset to 0, after which the control flow is reset.

In step S2, the flag F is checked by the control circuit 130. Because the flag F is in initially 0 in the first cycle of this control flow, step S3 is executed. If the flag F were 1, however, step S8 would be executed instead.

In step S3, it is determined by the control circuit 130 whether there is a determination to shift (i.e., whether there is a shift command). More specifically, it is determined whether a signal indicative of a need to shift the automatic transmission 10 into a relatively lower speed (i.e., a downshift) is being output from the manual shift determining portion 93.

In FIG. 20, the determination in step S3 is made at time t1. If it is determined in step S3 that a signal indicative of the need to downshift is being output from the manual shift determining portion 93 (i.e., YES in step S3), then step S4 is executed. If not (i.e., NO in step S3), the control flow is reset.

In the example described above, the accelerator is fully closed in step S1 at time t1, but it can be closed earlier, as long as it is closed before step S3 is performed at time t1. In regard to the signal indicating a need for a downshift output from the manual shift determining portion 93, the example in FIG. 20 shows a case in which it has been determined by the control circuit 130 that there is a need for a downshift at time t1. Based on the determination that there is a need to downshift at time t1, the control circuit 130 then outputs a downshift command at time t1 (step S6), as will be described later.

In step S4, a maximum target deceleration Gt is obtained by the control circuit 130. This maximum target deceleration Gt is made the same (or approximately the same) as a maximum deceleration (to be described later) that is determined by the type of shift (e.g., by the combination of the speed before the shift and the speed after the shift, such as 4th→3rd or 3rd→2nd) and the vehicle speed. The broken line denoted by reference numeral 602 in FIG. 20 indicates the deceleration corresponding to the negative torque (braking force, engine brake) of the output shaft 120c of the automatic transmission 10, and is determined by the type of shift and the vehicle speed.

The maximum target deceleration Gt is determined to be substantially the same as a maximum value (the maximum deceleration mentioned above) 602max of a deceleration 602 that acts on the vehicle from the shift of the automatic transmission 10. The maximum value 602max of the deceleration 602 from the shift of the automatic transmission 10 is determined referencing a maximum deceleration map stored in advance in the ROM 133. In the maximum deceleration map, the value of the maximum deceleration 602max is determined based on the type of shift and the vehicle speed. After step S4, step S5 is then executed.

In step S5, a gradient α of a target deceleration 603 is determined by the control circuit 130. When determining this gradient α, an initial gradient minimum value of the target deceleration 603 is first determined based on a time ta from after the downshift command is output (at time t1 in step S6, to be described later) until the shift (actually) starts (time t3), such that the deceleration that actually acts on the vehicle (hereinafter, this deceleration will be referred to as the “actual deceleration of the vehicle”) will reach the maximum target deceleration Gt by time t3 when the shift starts. In step S5, the gradient α of the target deceleration 603 is set larger than the gradient minimum value. The time ta from time t1 when the downshift command is output until time t3 when the shift actually starts is determined based on the type of shift.

A large portion (shown by the bold line in FIG. 20) of the target deceleration 603 in this exemplary embodiment is determined by steps S4 and S5. That is, as shown in FIG. 20, the target deceleration 603 is set to reach the maximum target deceleration Gt at the gradient α obtained in steps S4 and S5. Thereafter, the target deceleration 603 is maintained at the maximum target deceleration Gt until time t5 when the shift of the automatic transmission 10 ends. This is done in order to achieve a deceleration until the maximum deceleration 602max (≈maximum target deceleration Gt) produced by the shift of the automatic transmission 10 is reached, using the brakes, which have good response, while quickly suppressing deceleration shock. Realizing the initial deceleration with the brakes which have good response makes it possible to quickly control an instability phenomenon of the vehicle, should one occur. The setting of the target deceleration 603 after time t5 when the shift of the automatic transmission 10 ends will be described later. After step S5, step S6 is executed.

In step S6, the downshift command (shift command) is output from the CPU 131 of the control circuit 130 to the electromagnetic valve driving portions 138a to 138c. In response to this downshift command, the electromagnetic valve driving portions 138a to 138c energize or de-energize the electromagnetic valves 121a to 121c. As a result, the shift indicated by the downshift command is executed in the automatic transmission 10. If it is determined by the control circuit 130 at time t1 that there is a need for a downshift (i.e., YES in step S3), the downshift command is output at the same time as that determination (i.e., at time t1).

As shown in FIG. 20, when a downshift command is output at time t1 (step S6), the shift of the automatic transmission 10 actually starts at time t3, after the time ta determined based on the type of shift has passed after time t1. When the shift starts, clutch torque 608 starts to increase, as does the deceleration 602 from the shift of the automatic transmission 10. After step S6, step S7 is executed.

In step S7, a brake feedback control is executed by the brake control circuit 230. As shown by reference numeral 606, the brake feedback control starts at time t1 when the downshift command is output. That is, a signal indicative of the target deceleration 603 is output as the brake braking force signal SG1 at time t1 from the control circuit 130 to the brake control circuit 230 via the brake braking force signal line L1. Then based on the brake braking force signal SG1 input from the control circuit 130, the brake control circuit 230 then generates the brake control signal SG2 and outputs it to the hydraulic pressure control circuit 220.

The hydraulic pressure control circuit 220 then generates a braking force (a brake control amount 606) as indicated by the brake control signal SG2 by controlling the hydraulic pressure supplied to the brake devices 208, 209, 210, and 211 based on the brake control signal SG2.

In the feedback control of the brake system 200 in step S7, the target value is the target deceleration 603, the control amount is the actual deceleration of the vehicle, the objects to be controlled are the brakes (brake devices 208, 209, 210, and 211), the operating amount is the brake control amount 606, and the disturbance is mainly the deceleration 602 caused by the shift of the automatic transmission 10. The actual deceleration of the vehicle is detected by the acceleration sensor 90.

That is, in the brake system 200, the brake braking force (i.e., brake control amount 606) is controlled so that the actual deceleration of the vehicle comes to match the target deceleration 603. That is, the brake control amount 606 is set to produce a deceleration that makes up for the difference between the deceleration 602 caused by the shift of the automatic transmission 10 and the target deceleration 603 in the vehicle.

In the example shown in FIG. 20, the deceleration 602 caused by the automatic transmission 10 is zero from time t1 when the downshift command is output until time t3 when the automatic transmission 10 actually starts to shift. Therefore, the brake control amount 606 is set such that a deceleration that matches the entire target deceleration 603 is generated using the brakes. From time t3 the automatic transmission 10 starts to shift, and the brake control amount 606 decreases as the deceleration 602 caused by the automatic transmission 10 increases.

The distribution of the braking force of the front and rear wheels is also controlled in step S7. The method shown in FIG. 8, which is similar to that of the first exemplary embodiment, can be used for controlling the distribution of the braking force of the front wheels with respect to the braking force of the rear wheels. The value of the total braking force F in step SA10 in FIG. 8 corresponds to the brake control amount 606 in the third exemplary embodiment. After step S7, step S8 is executed.

In step S8, the control circuit 130 determines whether the shift of the automatic transmission 10 is ending (or close thereto). This determination is made based on the rotation speed of rotating members in the automatic transmission 10 (see input rotation speed in FIG. 20). In this case, the determination is made according to whether the following relational expression is satisfied.
No×If−Nin≦Nin

Here, No is the rotation speed of the output shaft 120c of the automatic transmission 10, Nin is the input shaft rotation speed (turbine rotation speed etc.), If is the speed ratio after the shift, and ΔNin is a constant value. The control circuit 130 inputs the detection results from a detecting portion (not shown) that detects the input shaft rotation speed Nin of the automatic transmission 10 (i.e., the turbine rotation speed of the turbine runner 24, etc.).

If that relational expression is not satisfied in step S8, it is determined that the shift of the automatic transmission 10 is not yet ending and the flag F is set to 1 in step S14, after which the control flow is reset. The routine then repeats steps S1, S2, and S8 until that relational expression is satisfied. If during that time the accelerator opening amount is anything other than fully closed, the routine proceeds to step S12 and the brake control according to this exemplary embodiment ends.

If, on the other hand, the foregoing relational expression in step S8 is satisfied, the routine proceeds on to step S9. In FIG. 20, the shift ends at (right before) time t5, whereby the relational expression is satisfied. As can be seen in FIG. 20, the deceleration 602 that acts on the vehicle from the shift of the automatic transmission 10 reaches the maximum value 602max (≈maximum target deceleration Gt) at time t5, indicating that the shift of the automatic transmission 10 has ended.

In step S9, the brake feedback control that started in step S7 ends. After step S9, the control circuit 130 no longer includes the signal corresponding to the brake feedback control in the brake braking force signal SG1 that is output to the brake control circuit 230.

That is, the brake feedback control is performed until the shift of the automatic transmission 10 ends. As shown in FIG. 20, the brake control amount 606 is zero at time t5 when the shift of the automatic transmission 10 ends. When the shift of the automatic transmission 10 ends at time t5, the deceleration 602 produced by the automatic transmission 10 reaches the maximum value 602max. At that time t5, the deceleration 602 alone produced by the automatic transmission 10 is sufficient to reach the maximum target deceleration Gt of the target deceleration 603 set (in step S4) to be substantially the same as the maximum value 602max of the deceleration 602 produced by the automatic transmission 10, so the brake control amount 606 can be zero. After step S9, step S10 is executed.

In step S10, the control circuit 130 outputs, and then gradually reduces, the brake torque (deceleration) for the amount of shift inertia to the brakes via the brake braking force signal SG1 that is output to the brake control circuit 230. The shift inertia is generated from between times t5 and t6 after the shift of the automatic transmission 10 has ended, through time t7 in FIG. 20. The shift inertia (i.e., inertia torque) is determined by a time differential value and an inertia value of a rotation speed of a rotating member of the automatic transmission 10 at time t5 when the shift of the automatic transmission 10 has ended.

In FIG. 20, step S10 is executed between time t5 and time t7. In order to keep shift shock to a minimum, the control circuit 130 sets the target deceleration 603 so its gradient is gradual after time t5. The gradient of the target deceleration 603 remains gradual until the target deceleration 603 reaches a final deceleration Ge obtained by a downshift of the automatic transmission 10. The setting of the target deceleration 603 ends when it reaches the final deceleration Ge. At that point, the final deceleration Ge, which is the engine brake desired by the downshift, acts on the vehicle as the actual deceleration of the vehicle, so from that point on, brake control according to the exemplary embodiment is no longer necessary.

In step S10, the brake control amount 606 for the shift inertia amount is supplied by the hydraulic pressure control circuit 220 in response to the brake control signal SG2 generated based on the brake braking force signal SG1 that was input to the brake control circuit 230. Then the brake control amount 606 is gradually reduced to correspond to the gradient of the target deceleration 603. After step S10, step S11 is executed.

In step S11, the control circuit 130 clears the flag F to 0 and resets the control flow.

The third exemplary embodiment describes a case in which, when a downshift is performed by a manual shift, cooperative control of the automatic transmission 10 and the brakes is executed while deceleration using the brakes is produced at an appropriate front/rear wheel distribution ratio in consideration of the deceleration produced by the speed. In the third exemplary embodiment, cooperative control of the automatic transmission 10 and the brakes can executed while deceleration using the brakes is produced at an appropriate front/rear wheel distribution ratio in consideration of the deceleration produced by the speed not only when a downshift is performed manually, but also when a downshift is performed according to a normal shift map (FIG. 5). The method for controlling the front/rear wheel distribution of the brake braking force in this case can be the same as for a manual shift.

This exemplary embodiment enables the following effects to be achieved. In addition to improved deceleration characteristics or greater deceleration, vehicle stability is also able to be ensured. In technology that cooperatively controls the transmission and the brake system, vehicle stability during braking is improved by controlling the braking force of the wheels based on a change in the engine braking force. The deceleration produced by the speed (i.e., the engine braking force) acts only on the driven wheels, whether they be the front wheels or the rear wheels. As a result, when a large deceleration produced by the speed is applied only to the driven wheels, sufficient stability of the vehicle may be unable to be achieved. In this exemplary embodiment, however, deceleration using the brakes is able to be produced at an appropriate front/rear wheel distribution ratio in consideration of the deceleration produced by the speed, so vehicle stability is able to be ensured.

This exemplary embodiment enables ideal deceleration transitional characteristics to be obtained, as shown by the target deceleration 603 in FIG. 20. The deceleration smoothly shifts from the driven wheels to the non-driven wheels. Thereafter as well, the deceleration smoothly shifts to the final deceleration Ge obtained by the downshift of the automatic transmission 10. These ideal deceleration transitional characteristics are further described below.

That is, immediately after it is confirmed (i.e., immediately after there has been a determination) that there is a need for a downshift in step S3 (time t1), the brake control (step S7) that starts upon that confirmation (i.e., at time t1) causes the actual deceleration of the vehicle to gradually increase both at a gradient α that does not produce a large deceleration shock and within a range in which it is still possible to control a vehicle instability phenomenon should one occur. The actual deceleration of the vehicle increases before time t3 when the shift starts until it reaches the maximum value 602max (≈maximum target deceleration Gt) of the deceleration 602 produced by the shift. The actual deceleration of the vehicle then gradually falls, without producing a large shift shock at the end of the shift (after time t5), until it reaches the final deceleration Ge obtained by the shift.

As described above, according to this exemplary embodiment, the actual deceleration of the vehicle starts to increase quickly, i.e., immediately after time t1 when it has been confirmed that there is a need for a downshift. The actual deceleration of the vehicle then increases gradually until it reaches, at time t2 before time t3 when the shift starts, the maximum value 602max (≈maximum target deceleration Gt) of the deceleration 602 produced by the shift. The actual deceleration of the vehicle is then maintained at the maximum target deceleration Gt until time t5 when the shift ends. If an instability phenomenon is going to occur in the vehicle from a temporal shift in the actual deceleration of the vehicle, as described above, it is highly likely that it will occur either while the actual deceleration of the vehicle is increasing to the maximum target deceleration Gt (between time t1 and time t2), or at the latest, by time t3 before the shift starts immediately after the actual deceleration of the vehicle has reached the maximum target deceleration Gt. During this period when it is highly likely that a vehicle instability phenomenon will occur, only the brakes are used to produce a deceleration (that is, the automatic transmission 10 which has not yet actually started to shift is not used to produce a deceleration). Because the brakes have better response than the automatic transmission, an instability phenomenon in the vehicle, should one occur, can be both quickly and easily controlled by controlling the brakes.

That is, the brakes can be quickly and easily controlled to reduce or cancel the brake braking force (i.e., the brake control amount 606) in response to an instability phenomenon of the vehicle. On the other hand, if an instability phenomenon occurs in the vehicle after the automatic transmission has started to shift, even if the shift is cancelled at that point, it takes time until the shift is actually cancelled.

Further, during the period mentioned above when the likelihood that an instability phenomenon will occur in the vehicle is high (i.e., from time t1 to time t2 or from time t1 to time t3), the automatic transmission 10 does not start to shift and the friction apply devices such as the clutches and brakes of the automatic transmission 10 are not applied, so no problem will result if the shift of the automatic transmission 10 is cancelled in response to the occurrence of an instability phenomenon in the vehicle.

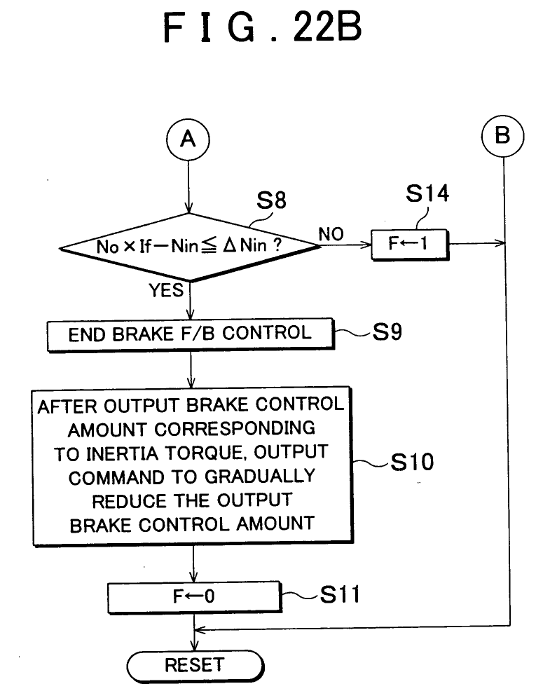

A fourth exemplary embodiment of the invention will now be described with reference to FIGS. 21A and 21B. In the following description of the fourth exemplary embodiment, only those parts that differ from the first exemplary embodiment will be described; descriptions of parts that are the same as those in the first exemplary embodiment will be omitted.

The fourth exemplary embodiment differs from the first exemplary embodiment (FIG. 1A) in that steps SB65 and SB71 have been added, as shown in FIG. 21A. The other structure of the fourth exemplary embodiment (FIG. 21A) is the same as that of the first exemplary embodiment (FIG. 1A) so a description thereof will be omitted.

In the first exemplary embodiment, distribution control of the brake braking force to the front and rear wheels is always performed (step S70) when brake control is performed. In contrast, in the fourth exemplary embodiment, distribution control of the brake braking force with respect to the front and rear wheels when brake control is being performed is only performed when there is a positive determination in step SB65, i.e., it is not performed when there is a negative determination in step SB65.

In step SB65, the control circuit 130 determines whether the steering angle is equal to, or greater than, a predetermined value or whether the road ratio μ is equal to, or less than, a set value. The control circuit 130 makes the determination of whether the steering angle is equal to, or greater than, the predetermined value, which is set beforehand, based on a signal indicative of the detection results from the steering angle sensor 91. Also, the control circuit 130 makes the determination of whether the road ratio μ is equal to, or less than, the set value, which is set beforehand, based on a signal indicative of the detection results from the road ratio μ detecting/estimating portion 92.

There is a tendency for the vehicle to become unstable when the steering angle is large or the road ratio μ is low and deceleration acts on the vehicle. Therefore, in situations in which the vehicle tends to become unstable (i.e., when the steering angle is large or the road ratio μ is low), it could be said that there is a great necessity for distribution control of the brake braking force on the front and rear wheels when brake control is performed. Thus, when the steering angle is equal to, or greater than, a predetermined value, or when the road ratio μ is equal to, or less than, a set value (i.e., YES in step SB65), distribution control of the brake braking force on the front and rear wheels is performed when brake control is being performed (step SB70), just as in step S70 in the first exemplary embodiment. On the other hand, when the steering angle is not equal to, or greater than, the predetermined value or the road ratio μ is not equal to, or less than, the set value (i.e., NO in step SB65), brake control (i.e., the same feedback control as in the first exemplary embodiment) is performed but the distribution control of the brake braking force is not (step SB71).

The fourth exemplary embodiment is a case in which shift point control is performed based on a corner radius, and in which there is a particularly high likelihood of the steering angle changing prior to turning the corner (i.e., before entering the corner). Thus it may be said that, compared with a case in which the vehicle is traveling on a straight section of road (in which the likelihood of the steering angle changing is low), the vehicle tends to become unstable when a deceleration acts on it. Moreover, in the fourth exemplary embodiment, when it is determined in step SB65 that either the steering angle is equal to, or greater than, the predetermined value or the road ratio is equal to, or less than, the set value, the distribution control of the brake braking force is executed so that the vehicle becomes stable.

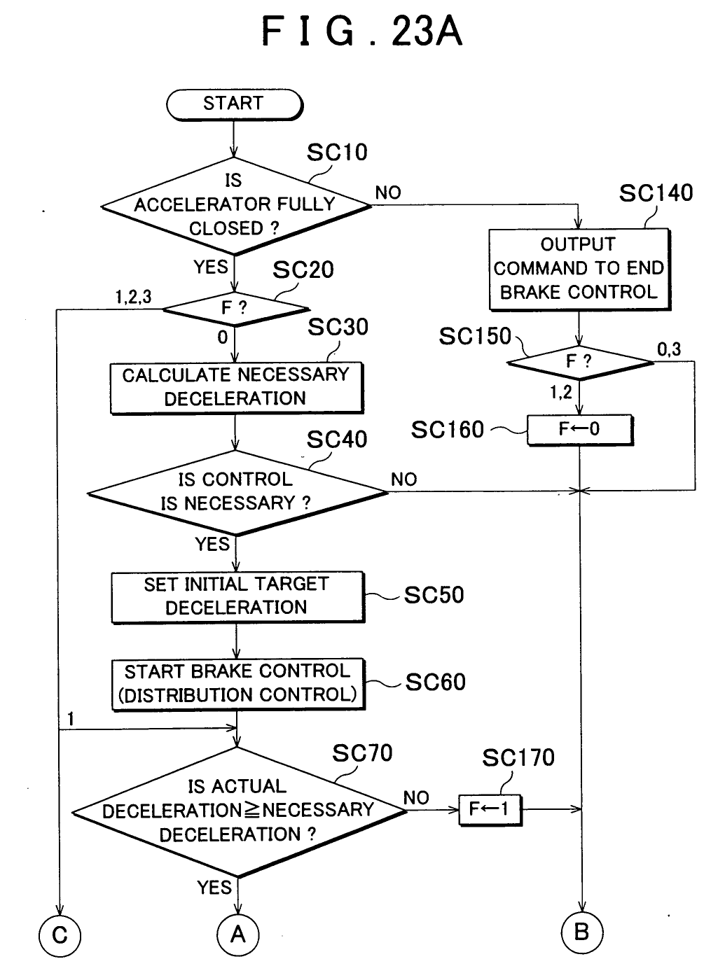

In the fourth exemplary embodiment, in the case where shift point control is performed based on the corner radius, the steering angle and the road ratio μ are determined and distribution control of the brake braking force is performed based on that determination. The concept of the fourth exemplary embodiment is not limited to being applied to a case in which shift point control is performed based on the corner radius. For example, when a downshift is performed by a manual shift on a straight section of road, it may be determined whether there is a corner ahead of the vehicle, whether the steering angle is equal to, or greater than, a predetermined value or whether the road ratio μ is equal to, or less than, a set value (step S6A), for example, as shown in FIGS. 22A and 22B. If there is a corner ahead of the vehicle, the steering angle is equal to, or greater than, the predetermined angle or the road ratio μ is equal to, or less than, the set value (i.e., YES in step S6A), distribution control of the brake braking force can be performed so that the vehicle can be made stable. The fourth exemplary embodiment describes a case in which shift point control is performed based on the corner radius, and presumes that there is a corner ahead of the vehicle. In the example shown in FIGS. 22A and 22B, however, no such presumption is made about the location (i.e., about a corner lying ahead of the vehicle). Since there is a greater tendency of the vehicle to become unstable when a deceleration acts on the vehicle when there is an upcoming corner than when traveling on a straight section of road, it is also determined in step S6A in FIGS. 22A and 22B whether there is an upcoming corner. In the event that there is an upcoming corner, distribution control of the brake braking force is executed.

Furthermore, when shift point control is performed or when a shift according to a normal shift map (FIG. 5) is performed based on the distance to a preceding vehicle or the road ratio μ or the like, it is then determined whether there is an upcoming corner, whether the steering angle is equal to, or greater than, the predetermined value or whether the road ratio μ is equal to, or less than, the set value, just as in step S7A. If there is an upcoming corner, the steering angle is equal to, or greater than, the predetermined value or the road ratio μ is equal to, or less than, the set value, the distribution control of the brake braking force is allowed to be performed. In this case, the threshold value of the road ratio μ in order to perform the distribution control of the brake braking force can be set to a lower value than the threshold value of the road ratio μ when shift point control based on the road ratio μ is performed.

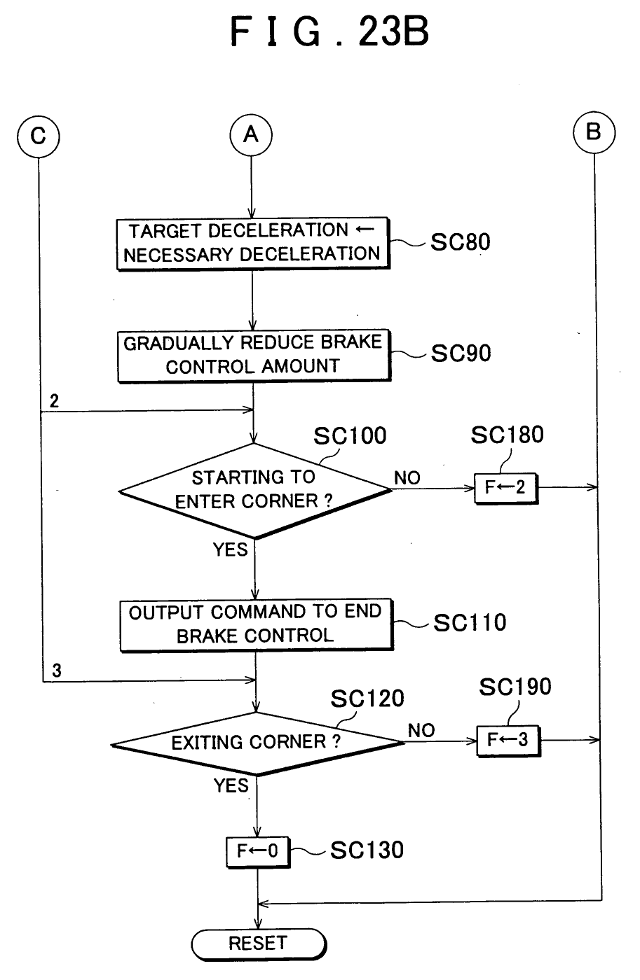

A fifth exemplary embodiment of the invention will now be described with reference to FIGS. 23 to 25. In the following description of the fifth exemplary embodiment, only the characteristic parts will be described; descriptions of parts that are the same as those in the foregoing exemplary embodiments will be omitted.

In the first to the fourth exemplary embodiments, deceleration control is performed by cooperative control of the brake system 200 and the automatic transmission 10. In the fifth exemplary embodiment, however, deceleration control is performed by the brake system 200 alone without using shift control of the automatic transmission 10. A contrastive description of the fifth exemplary embodiment with respect to the foregoing first exemplary embodiment is given below.

The fifth exemplary embodiment as shown in FIGS. 23A and 23B differs from the first exemplary embodiment as shown in FIGS. 1A and 1B in that in the fifth exemplary embodiment there are no steps which correspond to steps S50, S100, S130, and S150 of the first exemplary embodiment. According to the fifth exemplary embodiment, neither a downshift of the automatic transmission 10 nor a shift restriction is performed in the shift point control for a corner.

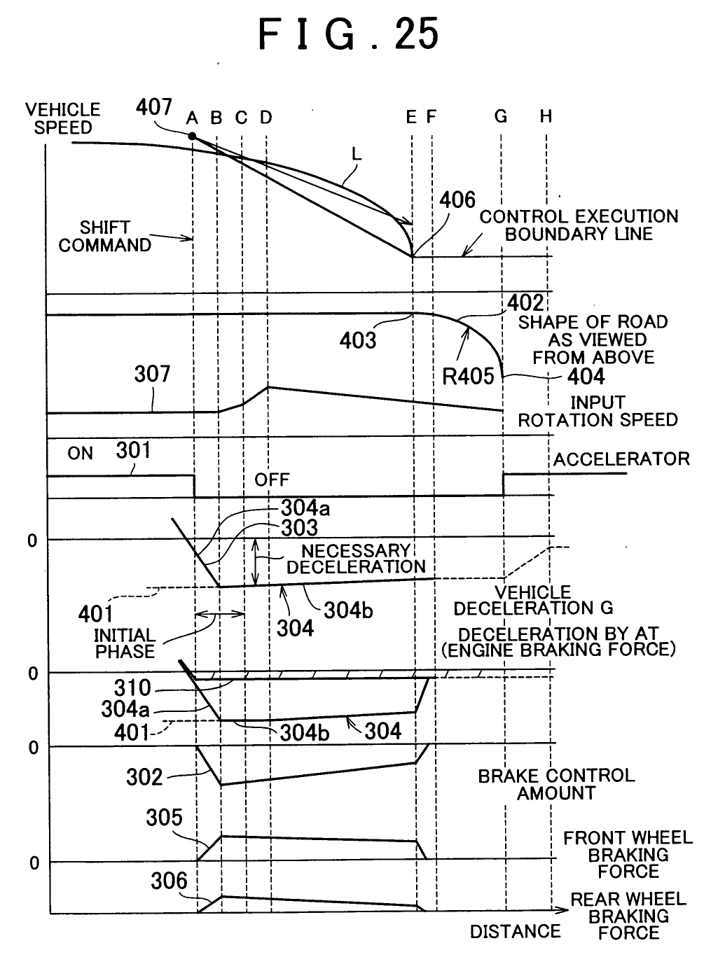

That is, in the fifth exemplary embodiment, deceleration corresponding to the necessary deceleration 401 or the target deceleration 304 is performed using only the brake system 200, as shown in FIG. 25. In the fifth exemplary embodiment, the brake system 200 alone is used to achieve the amount of deceleration that corresponds to the engine braking force that is produced by the shift of the automatic transmission 10 in the first exemplary embodiment.

In the fifth exemplary embodiment, deceleration corresponding to the necessary deceleration or the target deceleration is achieved using only the brake system 200, but similar to the first exemplary embodiment, distribution control of the braking force to the front and rear wheels is performed when the brake control (feedback control) in step SC60 is performed.

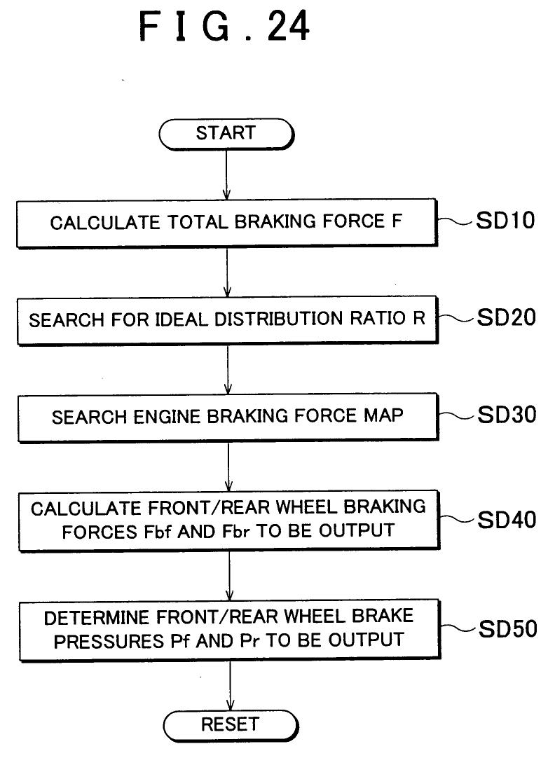

The distribution control of the braking force for the front and rear wheels can be executed according to the method shown in FIG. 24. The fifth exemplary embodiment as shown in FIG. 24 differs from the first exemplary embodiment as shown in FIG. 8 in that in the fifth exemplary embodiment there are no steps which correspond to steps SA30 and SA40 of the first exemplary embodiment. Since a downshift of the automatic transmission 10 is not executed in the fifth exemplary embodiment, there is no need for steps corresponding to steps SA30 and SA40.

In the fifth exemplary embodiment, deceleration control by a downshift of the automatic transmission 10 is not performed. Even if a shift is not performed, however, when brake control is executed, the accelerator must be off in order for the control to start, and when the accelerator is off, engine braking force acts on the driven wheels. In the fifth exemplary embodiment, the distribution control of the brake braking force for the front and rear wheels is performed taking into account this engine braking force produced by the speed which acts on the driven wheels.

The technology described above performs deceleration control of the vehicle irrespective of a shift of the transmission, using only the brake system when deceleration control of the vehicle is performed automatically based on the corner radius or the road gradient. The fifth exemplary embodiment, however, is not limited to control based on the corner radius or the road gradient. That is, technology that performs distribution control of the brake braking force for the front and rear wheels while taking into account the engine braking force produced by the speed which acts on the driven wheels when deceleration control is performed by the brake system 200 alone without using shift control of the automatic transmission 10 can also be applied to technology that performs deceleration control on a vehicle by operation of the brake system alone irrespective of a shift of the transmission when deceleration control of the vehicle is performed automatically based on various conditions ahead of the vehicle such as the distance to a preceding vehicle or the road surface μ, for example.

With technology that performs deceleration control of the vehicle using only the brake system, irrespective of a shift of the transmission, when deceleration control of the vehicle is performed automatically based on various conditions ahead of the vehicle such as a corner radius, road gradient, distance to a preceding vehicle, or road surface μ, it is desirable to decelerate the vehicle while keeping it stable during deceleration control because, compared to when the driver applies the foot brake, the intention to decelerate by a driver is relatively weak. In this exemplary embodiment, the vehicle is able to be decelerated while being kept stable during deceleration control because the braking force applied to the non-driven wheels and the braking force applied to the driven wheels is changed based on the engine braking force that acts on the driven wheels of the vehicle.

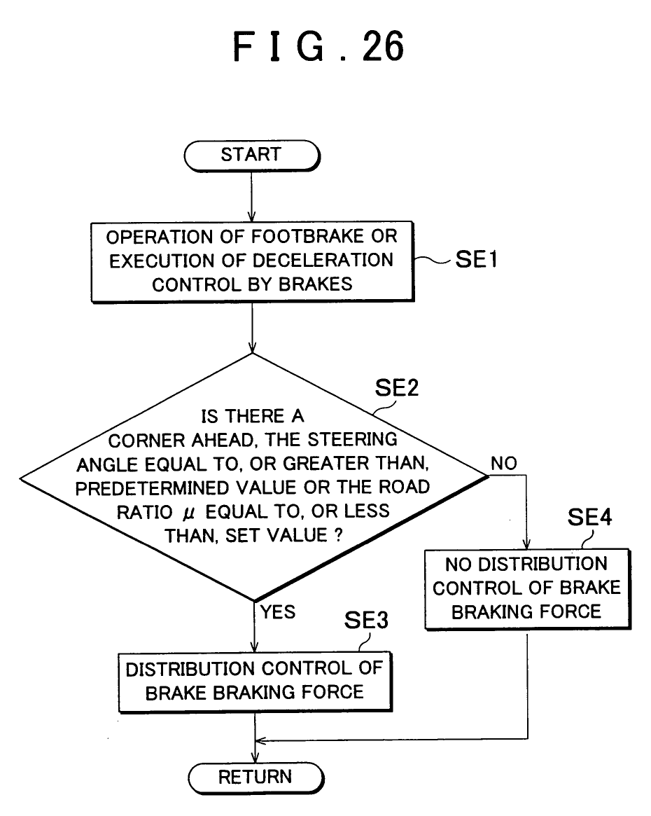

A sixth exemplary embodiment of the invention will now be described with reference to FIG. 26. In the following description of the sixth exemplary embodiment, only the characteristic parts will be described; descriptions of parts that are the same as those in the foregoing exemplary embodiments will be omitted.

As shown in FIG. 26, in a case (step SE1) in which the vehicle is decelerated by operation of the brakes, including a case in which the driver depresses the footbrake or a case in which deceleration control (automatic braking) is performed using only the brakes, distribution control of the brake braking force to the front and rear wheels is performed (step SE3) when i) there is a curve ahead of the vehicle, ii) the steering angle of the vehicle is equal to, or greater than, a predetermined value, or iii) the slipperiness of the road surface is equal to, or greater than, a set value (i.e., YES in step SE2). The method by which that distribution control is performed can be the same as that in FIG. 24.

It is desirable to keep the vehicle from becoming unstable when deceleration acts on the vehicle when it is decelerated using the brakes. In the sixth exemplary embodiment, the vehicle is able to be decelerated while being kept stable by changing both the braking force applied to the non-driven wheel and the braking force applied to the driven wheel of the vehicle based on the engine braking force applied to the driven wheel of the vehicle.

The brake control in each exemplary embodiment described above may also use a brake system that generates braking force in the vehicle other than the brakes described above, such as a regenerative brake by an MG (Motor-Generator) provided in a power train system. In this case, when an MG unit is provided for both the front wheel and the rear wheel, the front/rear wheel distribution ratio of the regeneration operating amounts by the MG unit can be controlled. When an MG unit is provided only for the front wheels in an FR vehicle, the engine braking force and the regeneration operating amount by the MG unit can be balanced.

In the foregoing description, the invention is described as applied to a stepped automatic transmission 10, but it may also be applied to a CVT (continuously variable transmission). Moreover, in the above description, the deceleration (G) is used as the deceleration indicative of the amount that the vehicle is to be decelerated. Alternatively, however, the control may be performed based on the deceleration torque.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A deceleration control apparatus for a vehicle, comprising:
a brake system that applies a braking force to the vehicle;
a transmission that changes a shift or a speed ratio of the vehicle; and
a controller that performs deceleration control on the vehicle by an operation of a brake system and a shift operation which shifts a transmission of the vehicle into a relatively low speed or speed ratio,
wherein the controller changes, as deceleration control, the braking force applied to a non-driven wheel of the vehicle and the braking force applied to a driven wheel of the vehicle based on a deceleration applied to the vehicle and engine braking force that acts on the driven wheel of the vehicle.

2. The deceleration control apparatus according to claim 1, wherein in the deceleration control, a target deceleration is set based on at least one of a curve ahead of the vehicle, a road gradient, slipperiness of a road surface, and a distance to a preceding vehicle, and the deceleration control is performed such that a deceleration applied to the vehicle matches the target deceleration.

3. The deceleration control apparatus according to claim 1, wherein in the deceleration control, when a shift command is output either in response to a manual operation by a driver or based on a shift map for shifting the transmission, a target deceleration corresponding to a shift in response to the shift command is set, and the deceleration control is performed such that a deceleration applied to the vehicle matches the target deceleration.

4. The deceleration control apparatus according to claim 1, wherein the braking force applied to the non-driven wheel of the vehicle and the braking force applied to the driven wheel of the vehicle are changed when there is a curve ahead of the vehicle, when a steering angle of the vehicle is equal to, or greater than, a predetermined value, or when the slipperiness of the road surface is equal to, or greater than, a set value.

5. The deceleration control apparatus according to claim 1, wherein feedback control in the brake system is performed based on the target deceleration of the deceleration control and the actual deceleration acting on the vehicle.

6. The deceleration control apparatus according to claim 1, wherein the brake system is at least one of means for braking a rotation of a vehicle wheel and means for generating power based on the rotation of the vehicle wheel.

7. A deceleration control apparatus for a vehicle, comprising:
a brake system that applies a braking force to the vehicle; and
a controller that performs deceleration control on the vehicle by operation of a brake system,
wherein the controller sets the target deceleration based on at least one of a curve ahead of the vehicle, a road gradient, slipperiness of a road surface, and a distance to a preceding vehicle,
wherein the controller changes the braking force applied to a non-driven wheel of the vehicle and the braking force applied to a driven wheel of the vehicle, based on an engine braking force acting on the driven wheel of the vehicle, when the deceleration control is performed such that a deceleration applied to the vehicle matches the target deceleration.

8. The deceleration control apparatus according to claim 7, wherein the brake system is at least one of means for braking a rotation of a vehicle wheel and means for generating power based on the rotation of the vehicle wheel.

9. A deceleration control apparatus for a vehicle, comprising:
a brake system that applies a braking force to the vehicle; and
a controller that performs deceleration control on the vehicle by operation of a brake system,
wherein the controller changes the braking force applied to a non-driven wheel of the vehicle and the braking force applied to a driven wheel of the vehicle when there is a curve ahead of the vehicle, when a steering angle of the vehicle is equal to, or greater than, a predetermined value, or when the slipperiness of the road surface is equal to, or greater than, a set value.

10. The deceleration control apparatus according to claim 9, wherein the brake system is at least one of means for braking a rotation of a vehicle wheel and means for generating power based on the rotation of the vehicle wheel.

11. A deceleration control method for a vehicle, which performs deceleration control on the vehicle by an operation of a brake system that applies a braking force to the vehicle and a shift operation which shifts a transmission of the vehicle into a relatively low speed or speed ratio, comprising:
changing, as deceleration control, the braking force applied to a non-driven wheel of the vehicle and the braking force applied to a driven wheel of the vehicle based on a deceleration applied to the vehicle and engine braking force that acts on the driven wheel of the vehicle.

12. The deceleration control method according to claim 11, wherein in the deceleration control, a target deceleration is set based on at least one of a curve ahead of the vehicle, a road gradient, slipperiness of a road surface, and a distance to a preceding vehicle, and the deceleration control is performed such that a deceleration applied to the vehicle matches the target deceleration.

13. The deceleration control method according to claim 11, wherein in the deceleration control, when a shift command is output either in response to a manual operation by a driver or based on a shift map for shifting the transmission, a target deceleration corresponding to a shift in response to the shift command is set, and the deceleration control is performed such that a deceleration applied to the vehicle matches the target deceleration.

14. The deceleration control method according to claim 11, wherein the braking force applied to the non-driven wheel of the vehicle and the braking force applied to the driven wheel of the vehicle are changed when there is a curve ahead of the vehicle, when a steering angle of the vehicle is equal to, or greater than, a predetermined value, or when the slipperiness of the road surface is equal to, or greater than, a set value.

15. The deceleration control method according to claim 11, wherein feedback control in the brake system is performed based on the target deceleration of the deceleration control and the actual deceleration acting on the vehicle.

16. A deceleration control method for a vehicle, which performs deceleration control on the vehicle by operation of a brake system that applies a braking force to the vehicle, comprising:
setting the target deceleration based on at least one of a curve ahead of the vehicle, a road gradient, slipperiness of a road surface, and a distance to a preceding vehicle; and
changing the braking force applied to a non-driven wheel of the vehicle and the braking force applied to a driven wheel of the vehicle, based on an engine braking force acting on the driven wheel of the vehicle, when the deceleration control is performed such that a deceleration applied to the vehicle matches the target deceleration.

17. A deceleration control method for a vehicle, which performs deceleration control on the vehicle by operation of a brake system that applies a braking force to the vehicle, comprising:
changing the braking force applied to a non-driven wheel of the vehicle and the braking force applied to a driven wheel of the vehicle when there is a curve ahead of the vehicle, when a steering angle of the vehicle is equal to, or greater than, a predetermined value, or when the slipperiness of the road surface is equal to, or greater than, a set value.
